(19) United States
(12) Patent Application Publication
(10) Pub. No.: US 2003/0034989 A1
(43) Pub. Date: Feb. 20, 2003

(54) Application editing apparatus and data processing method and program

(75) Inventor: Go Kondo, Tokyo-to (JP)

Correspondence Address: IBM CORPORATION, T.J. WATSON RESEARCH CENTER, P.O. BOX 218, YORKTOWN HEIGHTS, NY, 10598, US

(73) Assignee: IBM

(21) Appl. No.: 10/064,751

(22) Filed: Aug. 13, 2002

(30) Foreign Application Priority Data
Aug. 14, 2001 (JP) 2001-246290

(51) Int. Cl. G09G 5/00

(52) U.S. Cl. 345/630

(57) ABSTRACT

In an apparatus for editing an application having a model and a view separated from each other, there is provided an application A execution module for editing a first model in the application, a model converter for converting the first model into a second model, and an application B execution module for displaying the second model in its view on a display device. The application B execution module includes an event generator for generating an event based on an update made to the second model when the second model is updated and changes the view displayed on the display device based on the event generated by the event generator.

### BACKGROUND OF THE INVENTION

1. Field of the Invention

The present invention relates to a method of converting a model and displaying a view in an application having a model object and a view object separated from each other.

2. Background of the Invention

A basic approach to interactively writing an application program is to separate the application into a model object (hereinafter called “model”), which is logic of the application, and a view object (hereinafter called “view”), which is an implementation of the application displayed on a display device. Separating the application into the model and view allows a variety of views to be associated with one model. That is, one program can be used in a variety of display implementations according to processes or operations.

FIG. 36 illustrates the relationship between a model and views.

In the example shown in FIG. 36, three views, WYSIWYG (What You See Is What You Get), tree, and source views, are provided for one model (which has a tree structure). This means that a user can select any view from among the WYSIWYG, tree, and source views to display the application specified by the model shown in FIG. 36 in form suitable for a particular use such as viewing or editing the application.

If a change is made to the model through a certain view in the application, the change is reflected in the other views.

FIG. 37 shows how a change made in a certain view is reflected in the model and the other views in the application shown in FIG. 36.

When a write is performed in the WYSIWYG view in FIG. 37, it is reflected in the other views as follows (numbers in the following procedure correspond to reference numbers in FIG. 37).

1.A write to the view occurs.

2.A model object associated with the view object to which the change is made is changed (a node is added to the model in the example shown).

3.An event corresponding to the change is generated and broadcasted to the other views.

4.Each view interprets the event it received and makes a corresponding update.

The application in which models are separated from views has the advantage that a plurality of views can be added to or deleted from one model flexibly. However, to use a particular view for a particular model, the view must be adapted to a certain interface supporting the model so that a display according to the content of the model can be presented or the event generated in response to a change made to the model can be properly processed to cause the change to be reflected in the view.

Suppose that one wants to add a certain view to a certain model but there is no view having an interface supporting the model. There may be a number of solutions to this. The most straightforward method is to create a view having the required interface. However, creating a view for each desired model each time it is required entails too much working cost.

If there is a view having an interface used in a different application that is different from an interface required for the model, it can be considered that the view may be used for the model. A technique known as the adapter pattern can be used to adapt the interface to the model so as to allow the view to be used for the desired model. The adapter pattern is detailed in a document entitled “Design Pattern”, 1995, by Gamma, E., Helm, R., Johnson, R., and Vlissides, J., for example.

FIG. 38 schematically illustrates the adapter pattern.

It is assumed that each of applications A and B has a pair of a model and view compliant with an interface specific to it, as shown in FIG. 38A. View A of application A cannot be used to display model B of application B. However, an adapter adapting the interface of application A to the interface of application B can be used as shown in FIG. 38B to enable view A to be used for displaying model B.

Another method of using a view used in one application in a different application may be to use a model converter to cause the contents of a desired model to be reflected in a model in the other application and display it in the view in the other application.

FIG. 39 illustrates the method of using a view in a different application through model conversion to display a model.

As shown in FIG. 39, application A has view A1, which is a WYSIWYG view, and view 2, which is a tree view, for displaying model A. Application B has view B1, which is a source view, and view B2, which is a tree view, for displaying model B. Application C has view C, which is a source view, for displaying model C. Suppose that one wants to display a source view in application A but application A has no source view. Therefore, model A is converted into model B or C by using a model converter and displayed in source view form by using view B1 or C. Likewise, if a model is to be displayed in a WYSIWYG view in application B or C, or in a tree view in application C, the model may be converted into a node of the application that has an appropriate view, thereby allowing the view of that application to be used.

A typical example of the model converter is an XSLT (XSL Transformations) processor. Rules for model conversion performed by the XSLT are written in the XSL (extensible Style Language).

A typical implementation of the XSLT processor is Xalan provided by the Apache project. Xalan can convert a DOM (Document Object Model), which is a model in the XML, in addition to streams. The DOM conversion does not cause a change made to the contents of a model to be immediately reflected in a converted model (this type of conversion is hereinafter called dynamic conversion). Instead, it converts the entire model into another model (this type of conversion is hereinafter called static conversion). That is, a change made to the source model is reflected in the target model by converting the entire model to which the change is made. There are a variety of XSLT processors besides Xalan and most of them perform static conversion like Xalan.

An XSLT processor supplied with MSXML, which is an XML module available from Microsoft Corporation, allows conversion rules to be changed (although an input model to be converted is static and is not updated). This allows its target model and its view to be dynamically changed. However, this is in fact no more than static conversion performed for each individual rule. Therefore, it does not accommodate dynamic changes made to the source model.

Napa available from TFI Technology is an XSLT processor which receives an input as a stream, converts it progressively, and provides the result of the conversion to its output stream. In the sense that data is written to a source model read from the input stream, the source model is dynamically changed. However, the conversion itself is static conversion from one stream to another. Therefore, it does not support dynamic changes to the source.

Furthermore, a model converter is not only used by itself but also included in an editor for generating a preview model. Examples of such an editor including a model converter function are XML writer available from Wattle Software and Excelon Stylus available from eXcelon. These editors display a source model in a source code view (source view) for editing. If a user wants to see a preview display updated based on an edit, he or she calls the function of updating the preview by performing an explicit operation. In response to this operation, a model converter included in the editor converts the entire source model into a new model to update the preview, which is a view of the converted model.

As described above, a number of methods of addressing a case where a certain view is to be added to a certain model but there is no view having an interface supporting the model. However, these methods in which a required view having the required interface is created entail much creation cost.

The methods in which the Adapter pattern is used to adapt a view to a model having a different interface requires less cost than that for generating a view itself. However, an interface between a model and a view is complicated in some applications. If a narrow interface, that is, the smallest set of operations to be adapted, is large, generating the Adapter pattern requires much working cost.

Working cost for developing a model converter used for using a view supporting a different model is lower than cost for adapting a view to a model having a different interface.

However, model conversion by the model converter is static. Therefore, if a change is made to a source model, its converted model cannot immediately be updated with the change made to a view. That is, the source application cannot know what event is generated by the model for making the change to the view in the target application and therefore cannot make an update in such a manner that only a changed portion of the source model is reflected in its target view. Thus, the entire source model is converted into the target model and then a view is re-created based on the new, converted model.

Editors such as XML Writer and Excelon Stylus generate a preview model in addition to a model of an application and present a preview display using a view supporting the preview model, as described above. However, if a change is made to the model by an edit performed in the application, the change is not immediately reflected in the target preview model and view (hereinafter the combination of a model and view is called a model-view pair). Instead, a user should explicitly request an update of the target to convert the entire source model into the target model-view pair.

That is, even if the target model view pair is changed, the new, changed view is not a result of an update caused by an event transmitted from the target model to the view. Thus, this method is inefficient in that the old target model-view pair is discarded and the new, target model-view pair is generated based on the updated source model.

Especially, if the data size of one or both of the source model or target model is large, a large amount of time is required for processing each preview request. In terms of hardware, a large amount of memory space is consumed.

Furthermore, if data about a cursor position or the position of selected area that is generated during editing is held in a target model-view pair, because of re-creating the model-view pair rather than reflecting only a change made to the source model in the target model-view pair, the data is lost each time the model-view pair is re-created.

To address these problems, a method may be considered that causes a change made to the source model to be reflected in its target model and generates an event for causing the update in the target model to update the target view.

However, because the definition of the source model-view pair is typically different from that of the target model-view pair, the event for updating the target view cannot be generated from the update in the source model.

Therefore, an object of the present invention is, in a case where a view of a different application is used from a given model by using model conversion, to allow a change made to the source model to be dynamically reflected in its converted model and view to update the view.

Another object of the present invention is to provide a system that, in a case where a view of different application is used from a given model by using model conversion, makes a partial change corresponding to a change made to a source model to a target view to update the view.

### SUMMARY OF THE INVENTION

To attain these objects, the present invention provides an application editing apparatus for using a computer to edit an application having a model and a view separated from each other, including an editing module for editing a first model in the application; a model converter for converting the first model into a second model; and a view display module for using a view of the second model to display the second model on a display device. The view display module comprises an event generator for generating an event based on an update in the second model if the second model is updated based on an edit of the first model made by the editing module and changes the view displayed on the display device based on the event generated by the event generator.

The present invention also provides an application editing apparatus comprising:

an editing module for editing a first model in the application; a model converter for converting a first model into a second model; a view display module for using a view of the second model to display the second model on a display device; and an event converter for converting an event causing an update made to the first model to be reflected in a view of the first model into an event changing the view of the second model by using a model conversion rule; wherein, the view display module changes the view displayed on the display device based on the event generated by the event converter.

In this configuration, an event for changing a view of the second model can be generated without extracting a difference between the second models before and after the update.

The present invention also provides a data processing method of using a computer to display a model in a given application in a view in another application, including the steps of: reading a second model in the another application from a data storage and updating the second model so that the update made to the first model is reflected in the second model if a first model in the given application is updated; and generating an event based on the update made to the second model and, based on the event, changing the view displayed on a display device in the another application.

Also, the present invention can be implemented as a program configured as follows. The program controls a computer to execute an application having a model and a view separated from each other and causes the computer to perform the process steps of: reading a model in the application from a data storage storing the application and displaying a view of the model on a display device; extracting an difference between the models before and after an update if the model is updated; generating an event for changing the view based on the extracted difference; and changing the view displayed on the display device based on the generated event.

Alternatively, the present invention provides a program which controls a computer to edit an application having a model and view separated from each other and causes the computer to operate as: an editing module for editing a first model in the application; a model converter for converting the first model edited by the editing module into a second model; a difference extractor for extracting a difference between the second model and the second model previously converted if the first model is converted by the model converter into the second model; an event generator for generating an event based on the difference extracted by the difference extractor; and a view display module for displaying the second model in a view of the second model and, based on the event generated by the event generator, changing the view displayed on the display device.

Various other objects, features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF DRAWINGS

FIG. 1 schematically shows an exemplary configuration of a computer system suitable for implementing an application editing apparatus according to a first embodiment.

FIG. 2 shows functional blocks for editing an application according to the first embodiment.

FIG. 3 shows a relationship between a source application and a target application according to the first embodiment.

FIG. 4 shows a flowchart of a process for updating a model and view according to the first embodiment.

FIG. 5 shows an update process shown in FIG. 4 applied to a model-view pair shown in FIG. 3.

FIG. 6 shows functional blocks for editing an application according to a second embodiment.

FIG. 7 shows a conversion process performed by a model converter according to the second embodiment.

FIG. 8 shows a conversion process performed by a sub-converter according to the second embodiment.

FIG. 9 shows a flowchart of a conversion process performed by a model converter incorporation a conversion process performed by the sub-converter.

FIG. 10 shows model conversion in which the number of elements increases or decreases through after conversion.

FIG. 11 shows conversion shown in FIG. 10A divided into processes for individual elements.

FIG. 12 shows conversion shown in FIG. 10B divided into processes for individual elements.

FIG. 13 shows conversion shown in FIG. 10C divided into processes for individual elements.

FIG. 14 shows an example of model conversion in which a change in model B cannot be predicted from a change made to model A.

FIG. 15 shows functional blocks for editing an application according to a third embodiment.

FIG. 16 shows a flowchart of a process for updating a model and view according to the third embodiment.

FIG. 17 shows the update process shown in FIG. 16 applied to the model-pair shown in FIG. 3.

FIG. 18 shows model conversion by using typical conversion rules.

FIG. 19 shows an internal structure of a HTML editor in a first example.

FIG. 20 shows an exemplary display of view Jtree (0) in the first example.

FIG. 21 shows an exemplary display of view JTree (1) in the first example.

FIG. 22 shows an exemplary display of view JEditorPane in the first example.

FIG. 23 shows a section including a node (IMG0) in model HTMLDOM before the node (IMG0) is deleted.

FIG. 24 shows a section including a corresponding node (IMG1) in model SwingDocument converted from model HTMLDOM shown in FIG. 23.

FIG. 25 shows the section shown in FIG. 23 from which node IMG0 is deleted.

FIG. 26 shows model SwingDocument converted from model HTMLDOM shown in FIG. 25.

FIG. 27 shows an image displayed by using view JEditorPane that corresponds to model SwingDocument shown in FIG. 26.

FIG. 28 shows an internal structure of an XML editor in a second example.

FIG. 29 shows an example of XML data.

FIG. 30 shows an example of an XSL style sheet subject to model conversion.

FIG. 31 shows an example of XML data, which is a source model (model A) in the second example.

FIG. 32 shows compact HTML data, which is a target model (model B) obtained through model conversion of the model shown in FIG. 31.

FIG. 33 shows the HTML data in which a change made to the model shown in FIG. 31 is reflected.

FIG. 34 shows models A and B before a change is made to model A in a third example.

FIG. 35 shows models A and B after the change is made to model A.

FIG. 36 shows basic separation between a model and views according to prior art.

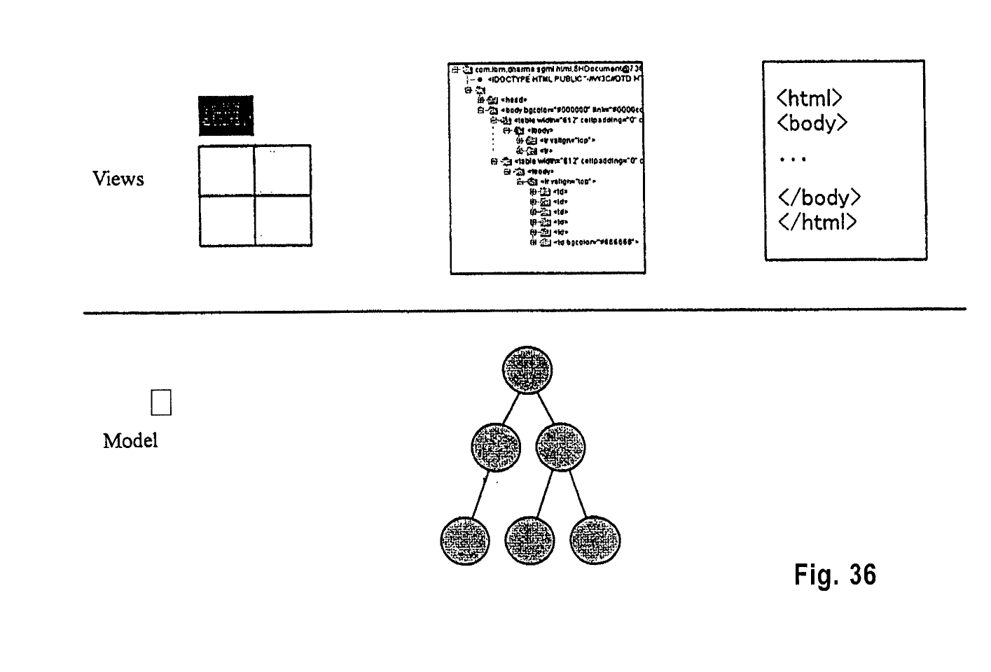

FIG. 37 shows how a change in a given view is reflected in a model and another view in the application shown in FIG. 36.

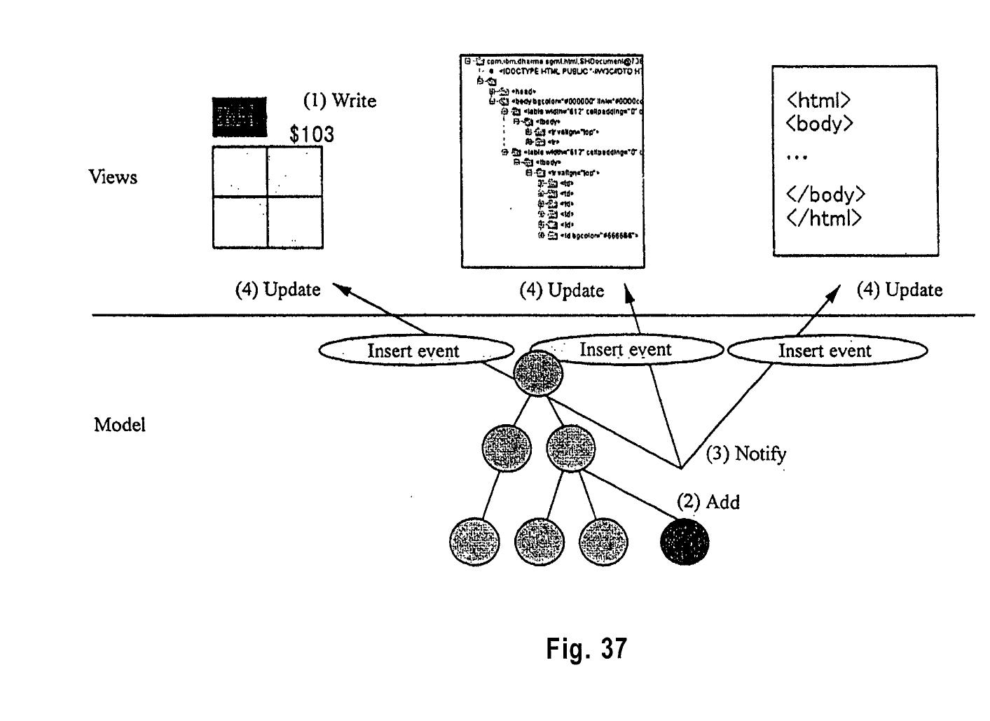

FIG. 38 schematically illustrates an Adapter pattern.

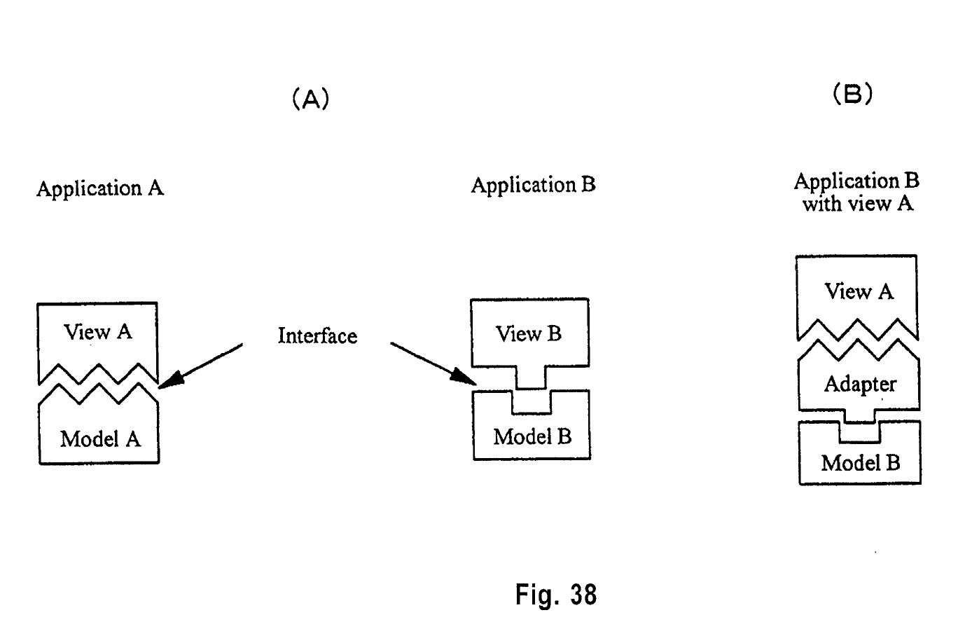

FIG. 39 shows a method of displaying a model by using a view of a different application through model conversion.

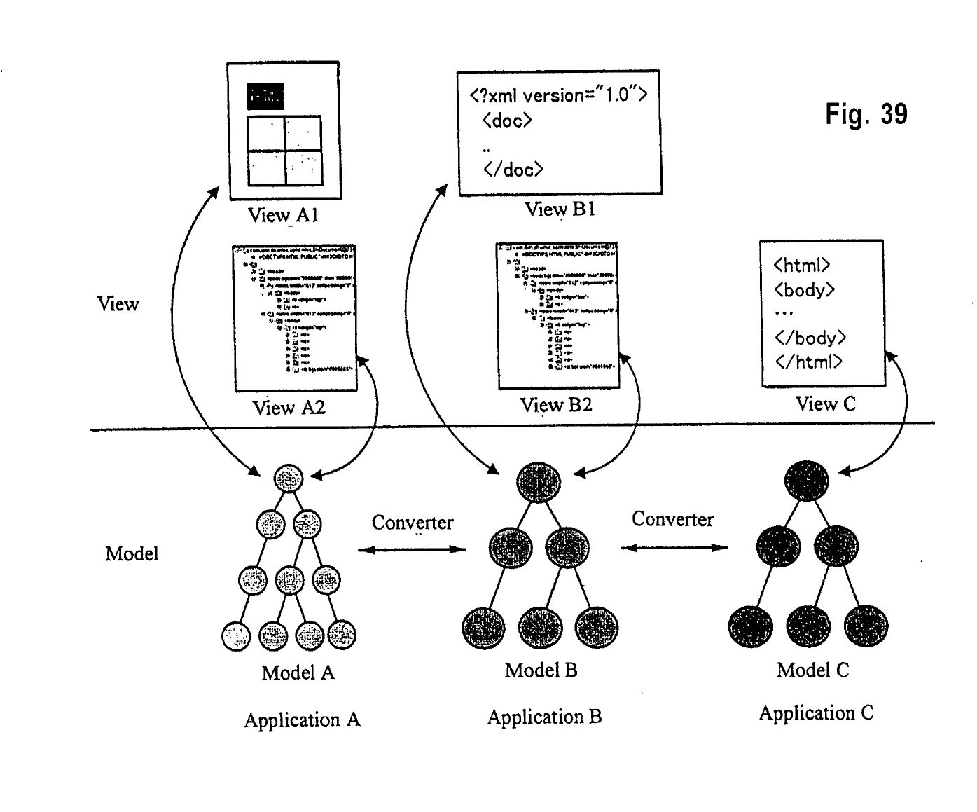

### DETAILED DESCRIPTION

The view display module may further comprise a difference extractor for extracting a difference between the second models before and after an update if the second model is updated based on an edit of the first model made by the editing module. The event generator generates the event by using information about the difference extracted by the difference extractor as a parameter.

The model converter may convert an individual element of the first model into a corresponding element of the second model. If the second model contains no element corresponding to a converted element of the first model, the model converter adds an element corresponding to the converted element to the second model.

In this configuration, elements that do not change when the second model is updated can be used as they are and information maintained between the second model and its view can be preserved.

The model converter may convert an element edited by the editing module in the first model into a corresponding element in second model and updates the second model with the converted element.

In this configuration, only those elements of the first model that were changed are converted into elements of the second model to cause the edit to be reflected in the second model. Thus, the efficiency of the model conversion can be improved.

In particular, the step of changing the view in the another application comprises the steps of extracting a difference between the second models before and after the update; making a change corresponding to the extracted difference to the second model to generate the event; and changing the view based on the event.

The step of updating the second model comprises the step of converting an individual element of the first model into a corresponding element of the second model, and the step of changing the view in the another application comprises the step of extracting a difference in the individual converted element of the second models before and after the update.

The step of changing the view in the another application comprises the step of converting an event causing the update made to the first model to be reflected in its view into an event changing the view in the another application, that is the second model, by using a conversion rule for concerting the first model into the second model.

The present invention will be described with respect to embodiments shown in the accompanying drawings.

The present invention relates to a method in an application having a model and a view separated from each other for using a view of a different application to display a model by using model conversion. If a change is made to the source model, the change is reflected in its target model by the model conversion. Then, an event is generated for updating the view based on the change made to the target model. The event allows the view to maintain the display of an unchanged portion of the source model and update the display of a portion corresponding to the change made to the source model.

According to a first embodiment, when a change is made to a source model, the entire source model is first converted into its target model, then a difference between target models before and after the change is extracted to identify the change. Then, an event according to the change is generated and sent to a view. The change is reflected in the view. Thus, a dynamic change of the view is implemented in application editing.

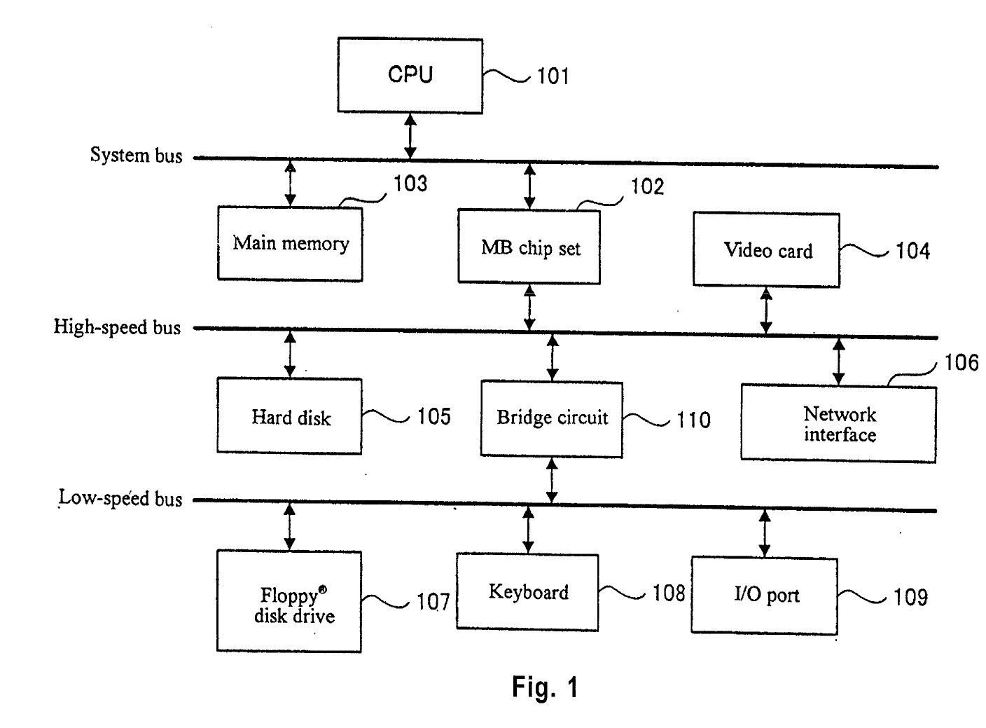

FIG. 1 schematically shows an exemplary configuration of a computer system suitable for implementing an application editing apparatus according to the first embodiment.

The computer system shown in FIG. 1 includes a Central Processing Unit (CPU) 101, a mother board (M/B) chip set 102 and main memory 103 connected to the CPU 101 through a system bus, a video card 104, hard disk 105, and network interface 106 connected to the M/B chip set 102 through a high-speed bus such as a PCI bus, a floppy® disk drive 107, keyboard 108, and I/O port 109 connected to the M/B chip set 102 through a low-speed bus such as an ISA bus and a bridge circuit 110.

The configuration of the computer system as the application editing apparatus according to the embodiment shown in FIG. 1 is only illustrative. Any other system configuration may be used to which the present embodiment is applicable. For example, a system may be possible in which a video memory alone is used instead of the video card 104 and the CPU 101 itself executes rendering instructions. Input means such as a mouse, voice input/output devices, and a CD-ROM drive, which are not shown, may be attached to a typical computer system.

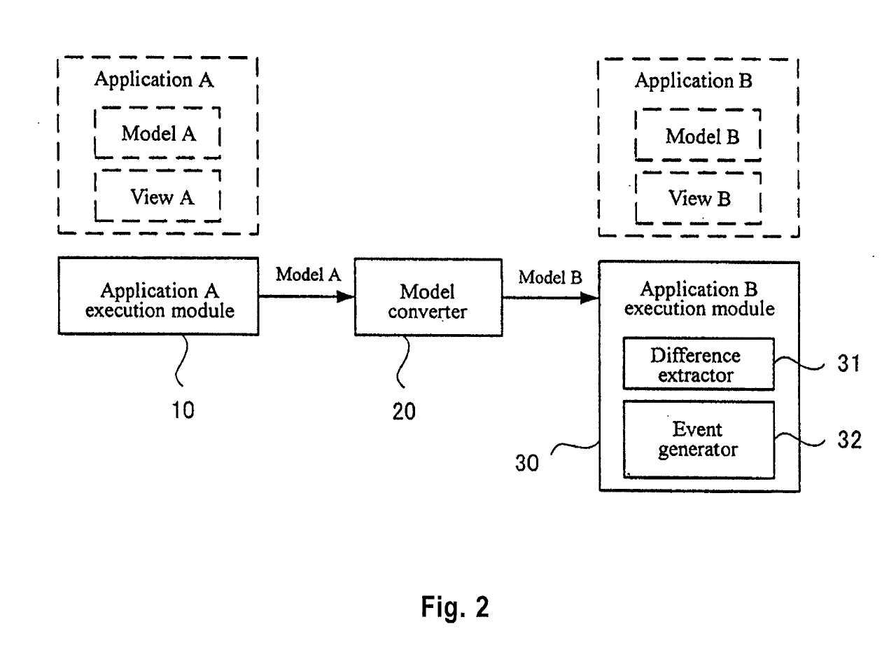

FIG. 2 shows functional blocks for editing an application in the program-controlled CPU 101 according to the first embodiment.

Referring to FIG. 2, provided in this embodiment are an application A execution module 10 for executing application A, a model converter 20 for converting model A in application A into model B in application B, and an application B execution module 30 for executing application B.

The application A execution module 10, model converter 20, and application B execution module 30 shown in FIG. 2 are virtual software blocks implemented by the CPU 101 controlled by a computer program loaded into the main memory 103 in FIG. 1. The computer program can be stored in a storage medium such as a CD-ROM or floppy® disk for delivery, or transmitted over a network and provided to a user. The program thus provided is read into the main memory 103 through the floppy® disk drive 107, a CD-ROM drive, not shown, or the network interface 106 and controls the CPU 101 to cause the computer system shown in FIG. 1 to implement the functions shown in FIG. 2.

Application A herein represents a source application to be converted and application B represents a target application. That is, when a particular application is dealt as a source application, then it is application A, and when it is dealt as a target application, then it is application B.

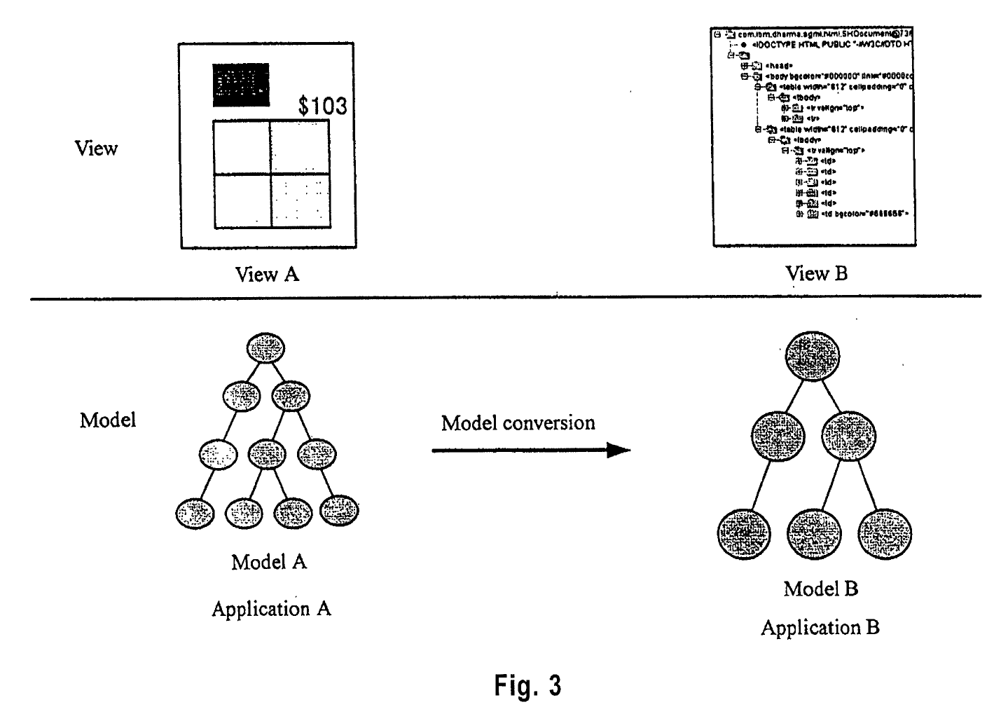

FIG. 3 shows the relationship between applications A and B.

As shown in FIG. 3, application A has model A having a tree structure and view A, which is a WYSIWYG view. Application B has model B having a tree structure and view B, which is a tree view. In this embodiment, model conversion is performed in order to display model A of application A by using view B of application B. While the number of views of each of applications A and B is not limited to one, it is assumed herein that application A and application B respectively have one view, A or B, for simplicity.

In the configuration shown in FIG. 2, the application A execution module 10 executes application A read into the main memory 103 in FIG. 1 and displays view A based on model A on a display device through the video card 104. The application A execution module 10 accepts an edit operation performed by a user on view A through editing means for model A, such as the keyboard 108. The operation is reflected in model A. If a change is made to model A through this edit operation, it is reported to the model converter 20.

The model converter 20 converts model A of application A to model B of application B. A method similar to those used for conventional model converters may be used. If the content of model A is changed by the application A execution module 10, changed model A is input into the model converter 20 in response to the report of the change and converted into model B, in which the change is reflected.

The application B execution module 30 executes application B read into the main memory 103 in FIG. 1 and displays view B based on model B on the display device through the video card 104.

If model B is updated, the application B execution module 30 updates view B based on the update. View B is updated based on difference between the source model and its converted model. To accomplish this, the application B execution module 30 has a difference extractor 31 and a event generator 32.

As described above, when model A is changed in the application A execution module 10, the model converter 20 updates model B with the change. The difference extractor 31 of the application B execution module 30 compares model B before the update with model B after the update to extract a difference.

When the difference is extracted by the difference extractor 31, the event generator 32 uses the difference as a parameter to generate an event. That is, it makes a change to source model B to fill the difference and generates an event for updating model B with the change.

The application B execution module 30 sends the event generated by the event generator 32 to view B to update it. Thus, the view B is updated so that unchanged portions in model B are displayed as it were before the update and the changed portion in which the change is reflected is displayed.

The application B execution module 30 holds changed model B. It may hold the result of the change made for generating the event by the event generator 32 or model B generated through the conversion by the model converter 20. If model B changed by event generator 32 is held, model B generated by the model converter 20 is wastefully discarded but data about a cursor position and the position of a selected area that is generated in editing and held in the source pair of model B and view B can be preserved.

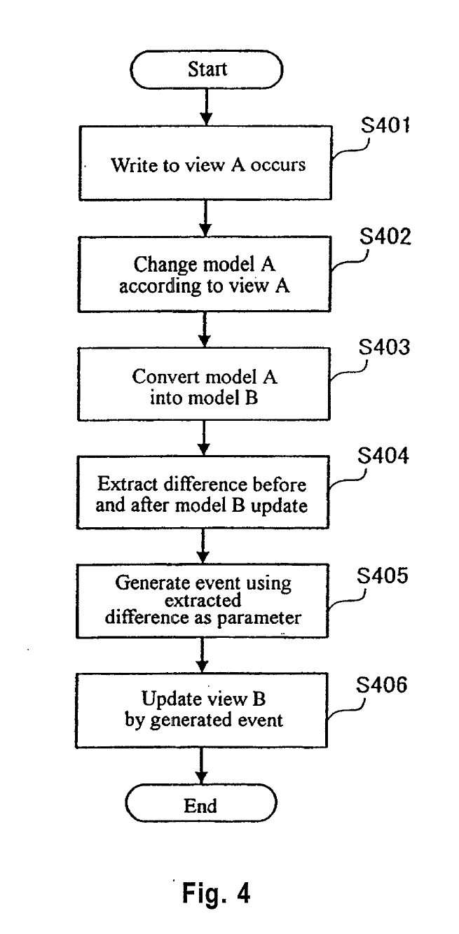

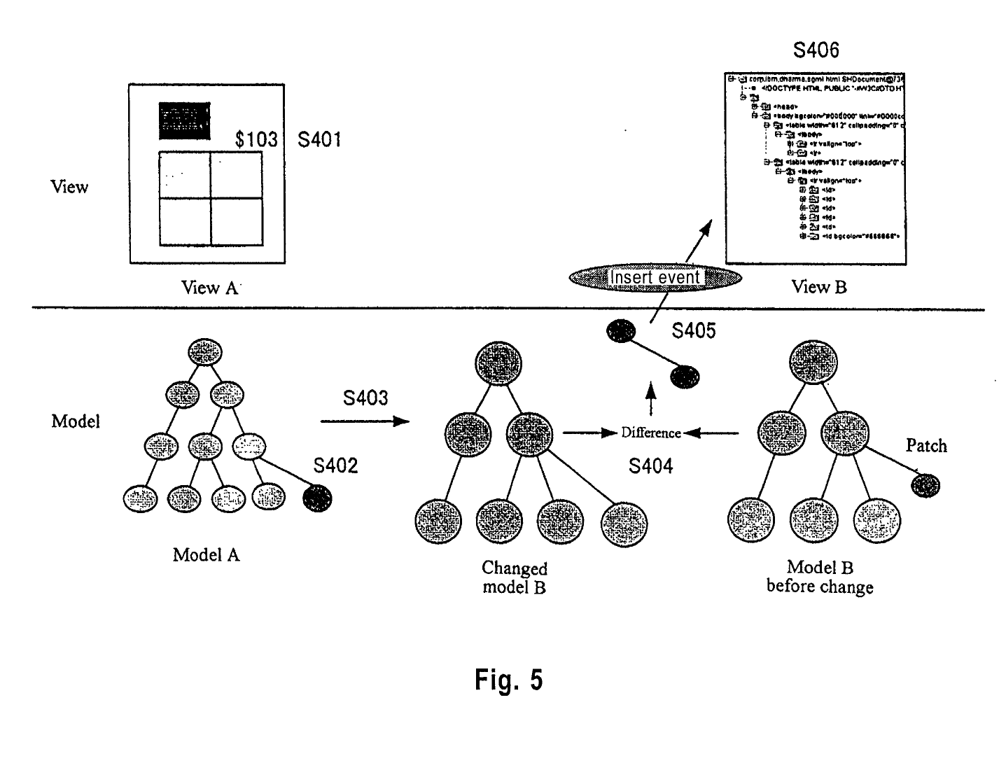

FIG. 4 shows a flowchart of a process for updating a model and view performed by the application A execution module 10, model converter 20, and application B execution module 30 described above. FIG. 5 shows the model-view pair shown in FIG. 3 to which the update process has bee applied. Reference numbers in FIG. 5 correspond to steps in FIG. 4.

As shown in FIG. 4, when a write to source view A occurs (step 401), the application A execution module 10 makes a change to model A according to changed view A (step 402). Then, the application A execution module 10 reports the update of the model A to the model converter 20.

The model converter 20 receives the report from the application A execution module 10, generates model B in which the change made to model A is reflected, and provides it to the application B execution module 30 (step 403).

The application B execution module B 30 receives model B in which the change of model A is reflected from model converter 20 and the difference extractor 31 extracts a difference between model Bs before and after the update (step 404). Then, the event generator 32 uses the difference as a parameter to generate an event (step 405). The event causes the view B to be updated with the change made to model A (step 406).

The above-described method of dynamically changing view B by using the difference between model Bs before and after update provides a high updating speed compared with a static update in which view B is re-created based on updated model B according to prior art. This allows view B to be updated immediately in response to an edit operation on view A performed in application A execution module 10. Thus, the user can perform editing while observing view B.

The improvement in speed of updating view B will be considered below in terms of processing cost.

Cost Vt1 for a process from the occurrence of a change in model A until view B is updated can be defined as follows:

Vt1=Vconv1+Vdiff1+Vupdate+Const. (1)

In equation (1), Vconv is model conversion cost. The computational complexity and memory space consumption is O (m), where m is the number of the elements of the source model (model A).

Vdiff is difference generation cost. The computational complexity is O (n), where n is the number of the elements of the target model (model B).

Vupdate is cost required for implementing the event and re-rendering by the target view (view B). The computational complexity is O (n), where n is the number of the elements of the target model (model B).

Const is processing cost for other steps (such as steps 401, 402, and 405), which is O (1) because it does not depend on the number of the elements of a model.

Values of O (m) and O (n) are amount of time which is not more than a constant multiple of m and n, respectively. O (1) means that the computation can be performed within a constant time period because 1 is a constant.

On the other hand, cost Vt0 for a period until view B is re-rendered in a method in which view B in which updated model B is reflected is re-created according to the prior art is defined as follows:

Vt0=Vconv+Vdraw+Const. (2)

In equation (2), Vview is cost for generating target view B. Both of the memory space consumption and computational complexity are expressed by O (n).

Vdraw is cost for initial rendering of target view B. The computational complexity is O (n).

As can be seen from definitional equations (1) and (2), comparison between Vt0 and Vt1 is equivalent to comparison between (Vdiff1+Vupdate) and (Vview+Vdraw). Here, the following relation holds.

Vupdate<<Vvinit

This is because interpreting an event and re-rendering an area relevant to the event in view B initial rendering of which has been already completed require far less time than re-rendering entire view B. Thereby, comparison between Vt0 and Vt1 resolves into comparison between Vdiff1 and Vview. The order of computational complexity is the same and therefore the relative advantage of Vdiff1 versus Vview cannot exactly be determined. However, at least in terms of memory consumption, Vdiff1 is advantageous over Vview.

The entire target model (model B) is generated in the model conversion in the first embodiment described above. Information required for updating view B is a difference between model Bs before and after the update and therefore the conversion of the remaining part is redundant. For a model consisting objects in a tree structure, original objects that are not changed can be reused to improve the efficiency of model conversion.

Therefore, model conversion is limited to a changed portion of a source model (model A) in a second embodiment.

Like the first embodiment, the second embodiment is implemented by a computer system as shown in FIG. 1.

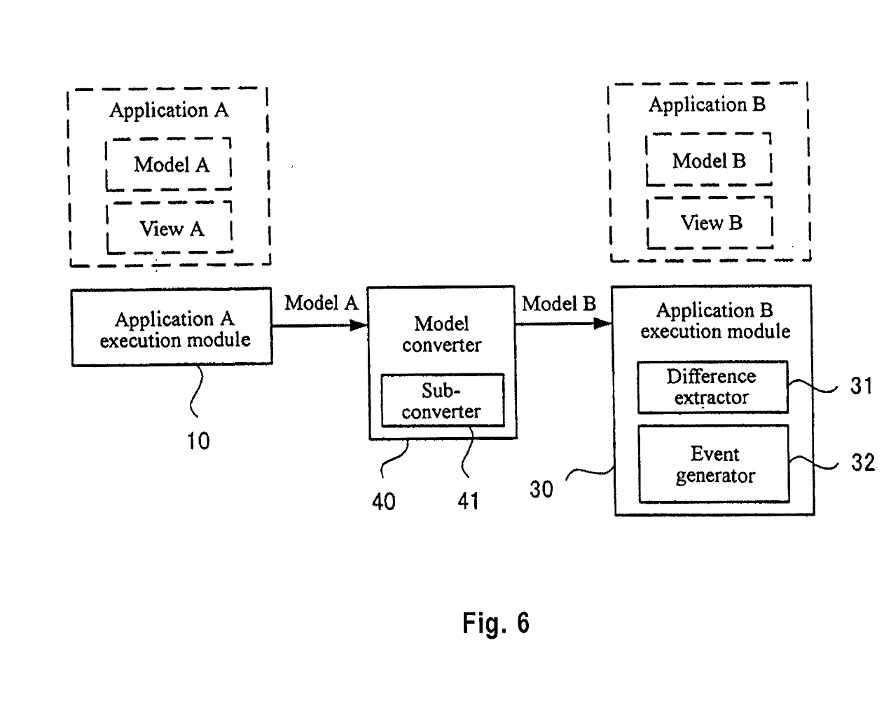

FIG. 6 shows functional blocks for editing an application according to the second embodiment.

Referring to FIG. 6, provided in the second embodiment are an application A execution module 10 for executing application A, model converter 40 for converting model A of application A into model B of application B, and an application B execution module 30 for executing application B.

Among these components, the application A execution module 10 and application B execution module 30 are the same as those shown in FIG. 2 and are therefore labeled with the same reference numbers and the description of which will be omitted. The relationship between application A and application B is the same as that described with reference to FIG. 3 in the first embodiment.

The model converter 40 shown in FIG. 6 is a virtual software block implemented by a CPU 101 controlled by a computer program loaded into main memory 103 shown in FIG. 1, like the components shown in FIG. 2.

In the configuration shown in FIG. 6, model A and source model B before a change are input into the model converter 40 and changed model B is outputted. When conversion is performed for the first time, only model A is input and regular conversion is performed because there is no source model B.

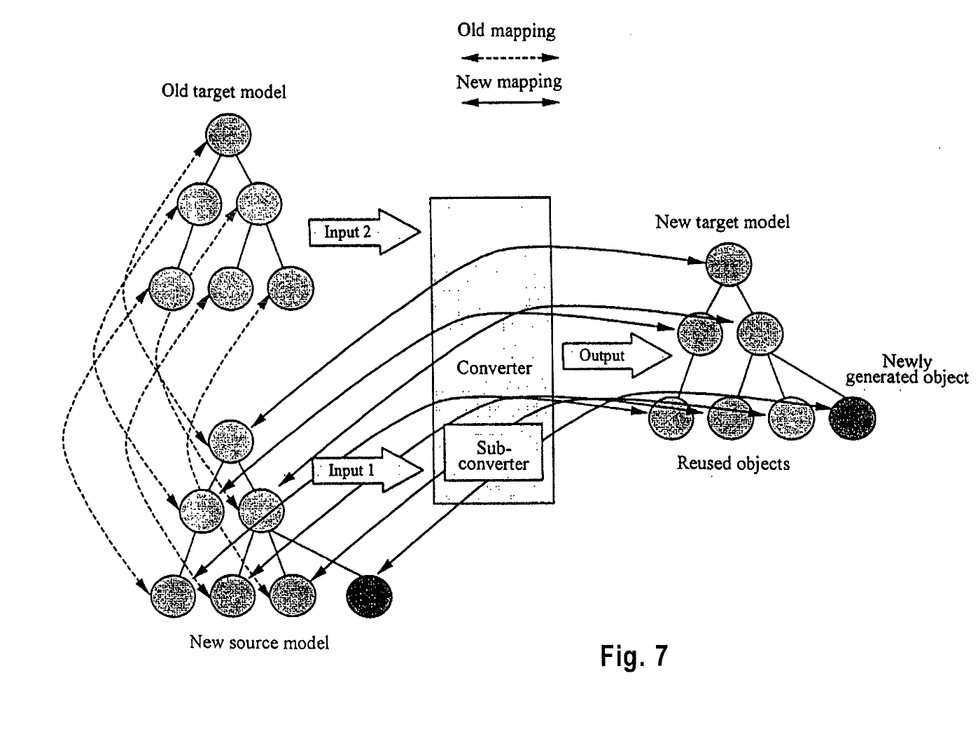

FIG. 7 shows how conversion is performed by the model converter 40.

As shown in FIG. 7, the model converter 40 compares each element of the model A with each element of model B before change and makes a change to model B that corresponds to a change made to A.

The conversion shown in FIG. 7 can be divided into operations for replacing elements of model A with elements of model B. The model converter 40 contains a sub-converter 41 for the element conversion, as shown in FIG. 6.

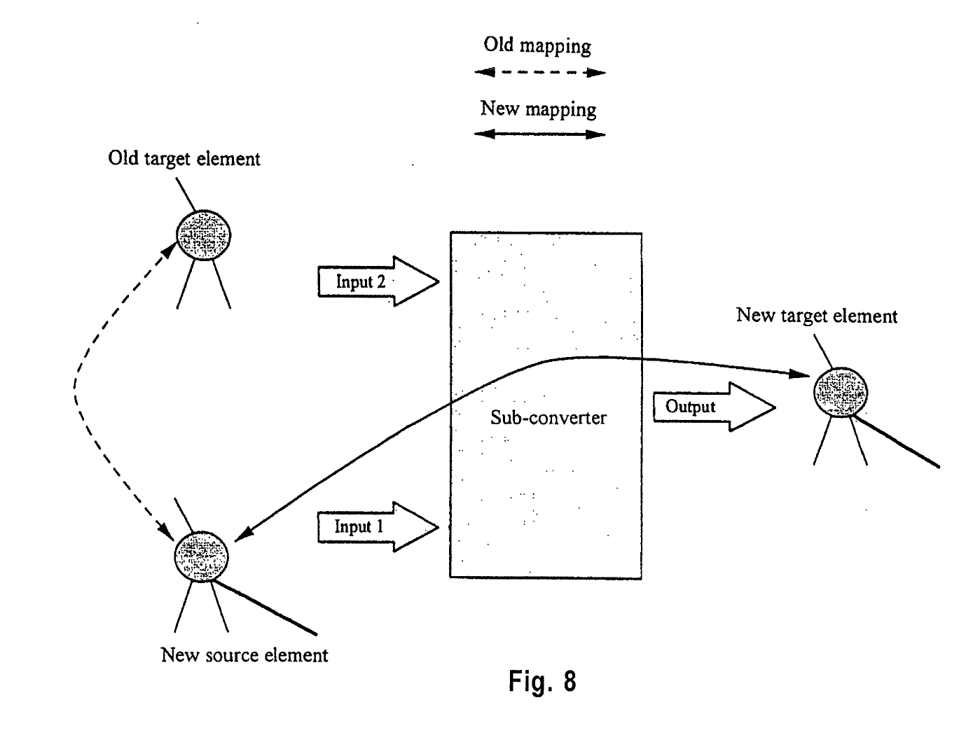

FIG. 8 shows how conversion is performed by the sub-converter 41.

As shown in FIG. 8, an element to be converted in model A and a corresponding element of model B before change are input into the sub-converter 41 and the sub-converter 41 makes a required change to the corresponding element of model B and outputs it.

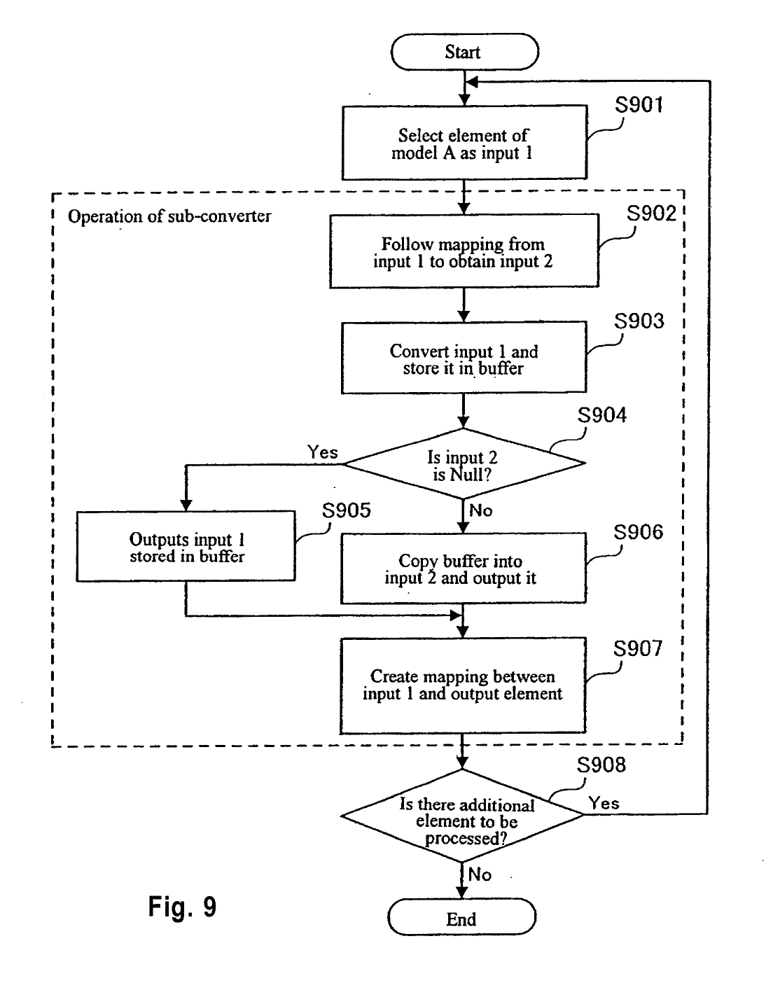

FIG. 9 shows a flowchart of a model conversion process performed by the model converter 40 incorporating a conversion process performed by the sub-converter 41.

As shown in FIG. 9, when model A and model B are input, the model converter 40 selects elements of model A one by one to input them as input 1 into the sub-converter 41 sequentially (step 901).

When an element of model A is input into the sub-converter 41, it follows the mapping of model B and obtains a corresponding element as input 2 into it (step 902). If no corresponding element is contained in model B, null is input as input 2.

Then, the sub-converter 41 converts the element, which is input 1, of model A based on a predetermined conversion rule into a corresponding element of model B and temporarily stores it in a buffer (step 903). If input 2 is null, then the sub-converter 41 outputs the converted element, input 1, stored in the buffer (steps 904 and 905). If input 2 was not null, then it copies the buffer into it as an output (steps 904 and 906). That is, if the corresponding element of model A depends on model B, the corresponding element is output. If no corresponding element is contained in model B, the result of the conversion at step 903 is output.

Then, the sub-converter 41 creates mapping between the input 1 element and the output element and then ends the conversion process (element conversion) of the element (step 907).

After the completion of the element conversion, the model converter 40 determines whether there is an additional element to be processed and, if there is one, repeats the above-described process (step 908). After the above-described process is performed for all the elements of model A, the process ends.

The model converter 40 described above allows for reduction in memory consumption of cache memory of the CPU 101 and the main memory 103 in FIG. 1 for the conversion process.

In addition, when the result of the conversion of the element, input 1, of model A is stored in the buffer at step 902, it can be compared with the corresponding element of model B and if they are different from each other, the difference can be extracted as a difference between model Bs before and after update, thereby simplifying a difference extraction process performed by the application B execution module 30. That is, instead of comparing model B before update with model B after update in application B execution module 30 to extract a difference, a difference extracted by comparison between elements during element conversion in the model converter 40 may be used to generate an event for updating view B.

Elements of model A are not always in one-to-one correspondence with elements of model B. An increase or decrease in the number of elements (which occurs if one element of model A corresponds to a plurality of combinations of elements of model B, or a plurality of combinations of elements of model A correspond to one element of model B) may be addressed by the recursive process using the sub-converter 41 described above.

A specific example of such model conversion will be described below.

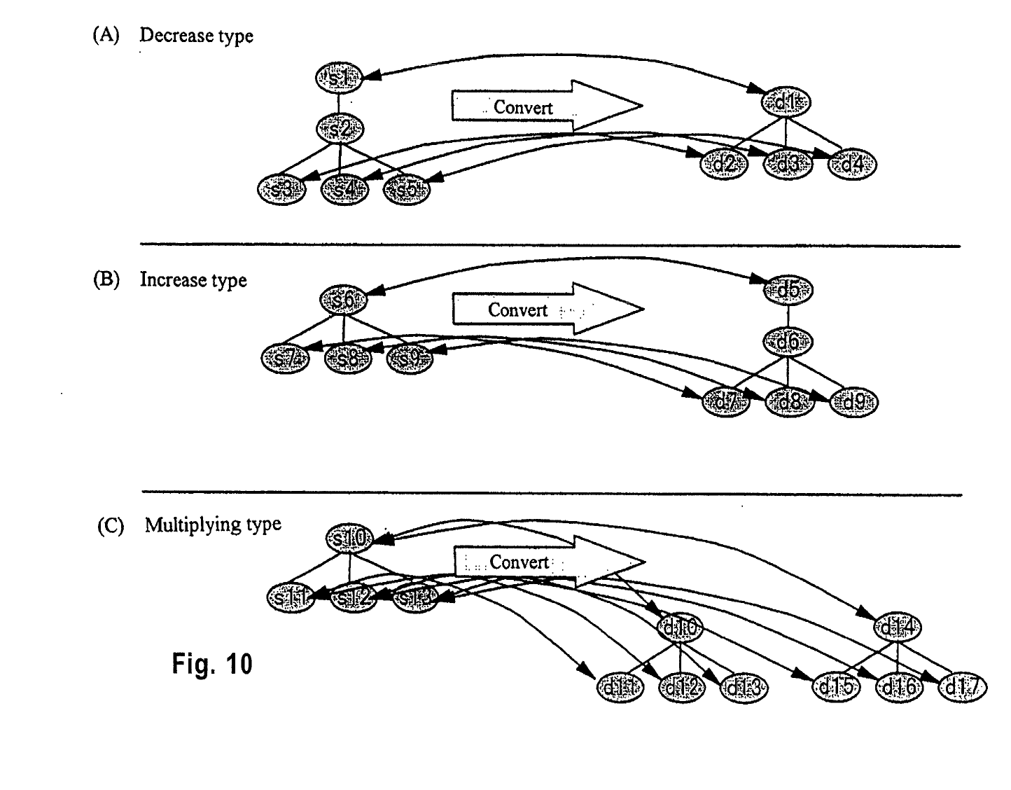

FIG. 10 illustrates this type of model conversion. In this example, models A and B are both represented as tree structures of objects. A node of the trees in models A and B has an array-type attribute called “child”, which represents a child node of that node. Conversion in which the number of elements of model B that correspond to elements of model A increases or decreases can be broadly divided into three types: decrease, increase, and multiplying types.

The decrease type will be described first.

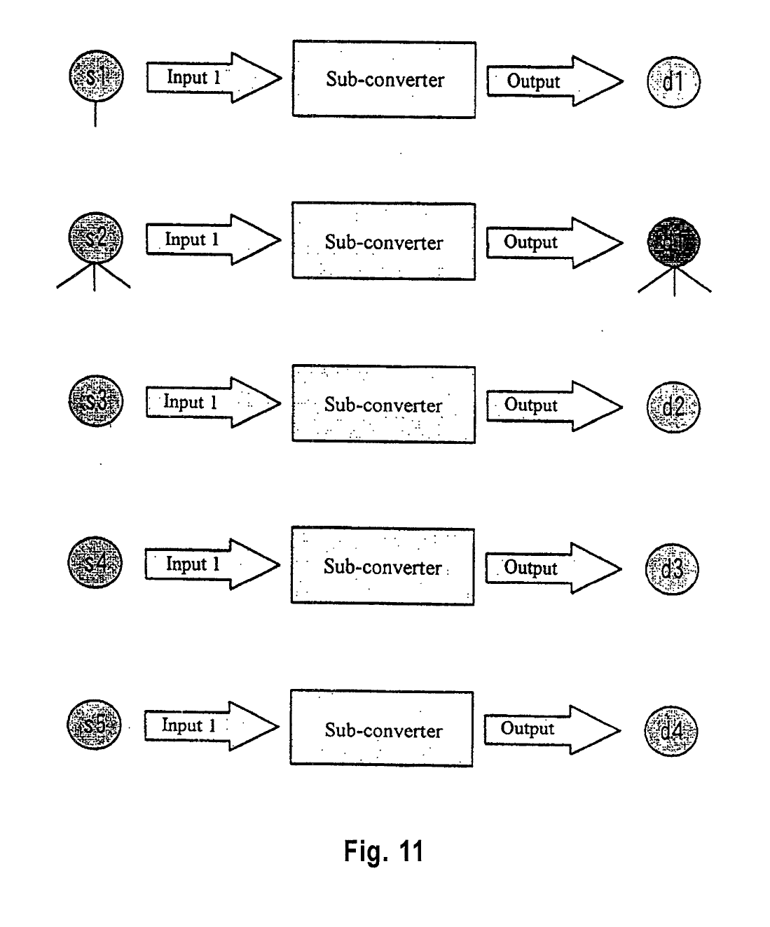

FIG. 10A shows how a decrease-type conversion is performed. FIG. 11 shows the conversion in FIG. 10A divided into processes for individual elements.

Referring to FIGS. 10A and 11, first, node s1 of model A is converted into node d1 of model B. Then, because there is no node corresponding to node s2 in model B, null is assumed. The descendants of node s2 in model A are associated with the descendants of node d1 in model B. This causes nodes s3, s4, and s5, which are the descendants of node s2, to be converted into nodes d2, d3, and d4 in node B, respectively.

Conversion rules for accomplishing this conversion are shown below.

1.s1−>d1

2.s1.child (0)−>Null

3.s2−>Null

4.s2.child (0) d1.child (0)

5.s2.child (1)−>d1.child (1)

6.s2.child (2)−>d1.child (2)

7.s3−>d2

8.s4−>d3

9.s5−>d4

Next, the increase type will be described below.

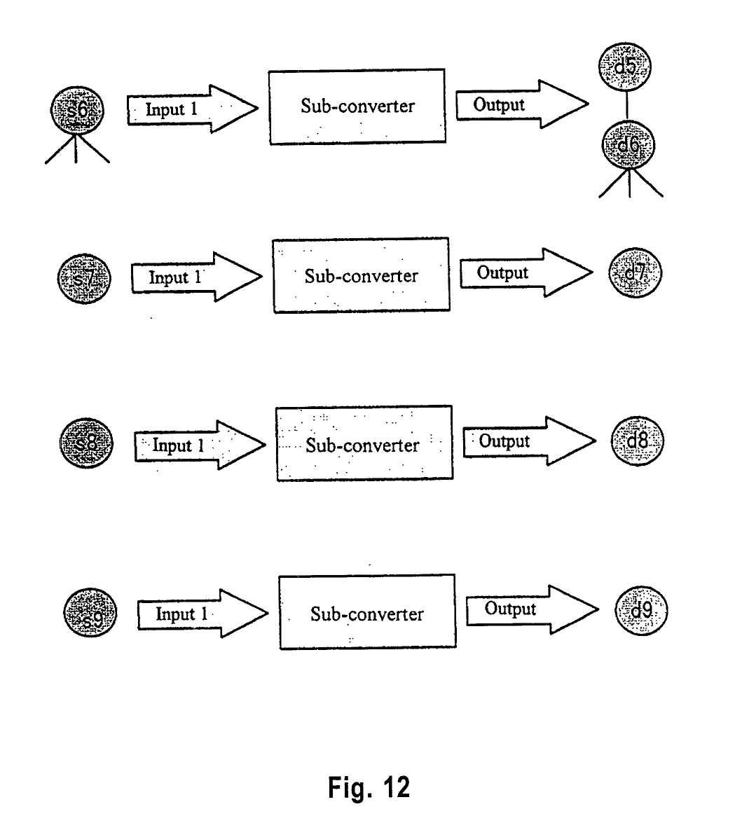

FIG. 10B shows how an increase-type conversion is performed. FIG. 12 shows the conversion in FIG. 10B divided into processes for individual elements.

Referring FIGS. 10B and 12, first, node s6 of model A is converted into nodes d5 and d6 of model B. Here, node d6 is described as the child attribute of node d5 (this indicates that node d6 is a child node of node d5). Then the descendants of node s6 in model A are associated with the descendants of node d6 in model B. This then causes nodes s7, s8, and s9, which are the descendants of node s6, to be converted into nodes d7, d8, and d9 in node B, respectively.

Conversion rules for accomplishing this conversion are shown below.

1.s6−>d5, d6, d5.child (0)=d6

2.s6.child (0)−>d6.child (0)

3.s6.child (1)−>d6.child (1)

4.s6.child (2)−>d6.child (2)

5.s7−>d7

6.s8−>d8

7.s9−>d9

Next, the multiplying type will be described below.

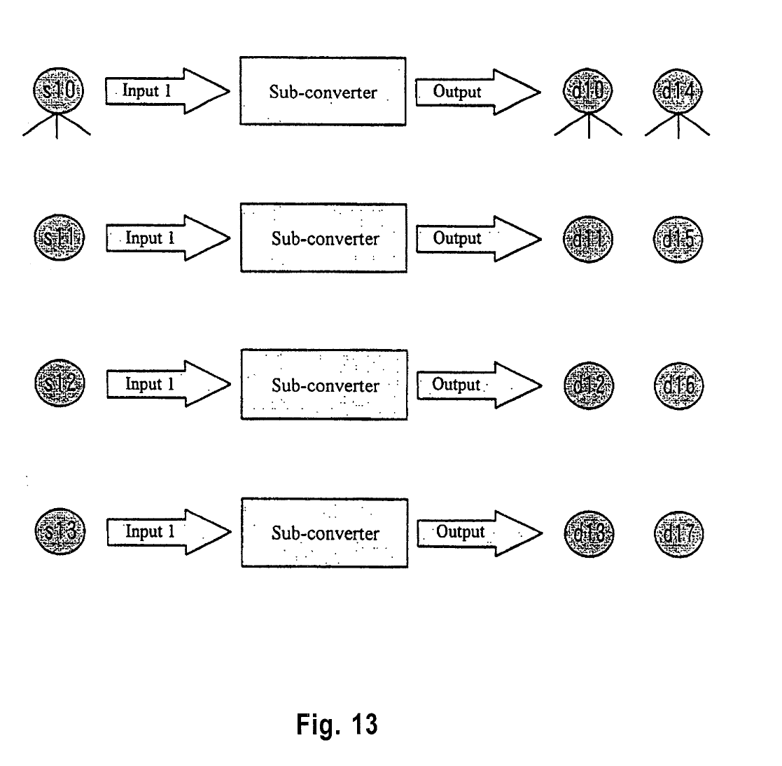

FIG. 10C shows multiplying-type conversion. FIG. 13 shows the conversion in FIG. 10C divided into processes for individual elements.

Referring FIGS. 10C and 13, first, node s10 of model A is converted into nodes d10 and d14 of model B. Then, the descendants of node s10 in node A are associated with the descendants of nodes d10 and d14 in model B. This then causes nodes s1 to be converted into nodes d11 and d15 of model B, node s12 into nodes d12 and d16 of model B, and node s13 into nodes d13 and d17 of model B.

Conversion rules for accomplishing the conversion will be shown below.

1.s10−>d10, d14

2.s10.child (0)−>d10.child (0), d14.child (0)

3.s10.child (1)−>d10.child (1), d14.dhild (1)

4.s10.child (2)−>d10.child (2), d14.child (2)

5.s11−>d11, d15

6.s12−>d12, d16

7.s13−>d13, d17

Memory space of the cache memory of the CPU 101 and the main memory 103, which is consumed for storing model B each time a change is made to model A in the first embodiment, is not consumed according to the second embodiment. Thus, in model conversion cost Vconv (see equations (1) and (2)), the memory space consumption will be O (1) and the computational complexity will be O (m), resulting in a significant improvement in the efficiency of memory usage.

In the second embodiment, model conversion is performed on an element basis to eliminate unnecessary conversion of unchanged portions of a source model (model A). However, if a portion in the target model (model B) which would be changed can be predicted based on information such as an event that occurs in application A in response to a change made to model A, the efficiency of processes for generating new model B through model conversion and for extracting a difference between model Bs before and after update can be improved.

That is, depending on the types of source application A and target application B (therefore the types of model A and model B) and changes made to model A, portions of model B that would be changed can be predicted.

In particular, the prediction can be made, provided that a change made to an element of model A does not affect the elements of model B except for a element or elements corresponding to it.

If such prediction can be made, the model converter 40 does not need to process all the element of models A and B by using the sub-converter 41. It needs to process only the predicted change portions by the sub-converter 41.

Also, the application B execution module 30 does not need to extract a difference between entire model Bs before and after update. Instead, it is only necessary for it to extract a difference before and after update in elements processed by the sub-converter 41.

This method can also be applied to conversion in which the number of elements model B correspond to element of model A increases or decreases, thereby improving the efficiency of difference extraction.

A first approach for applying this method to such conversion is to extend a range from which a difference is generated to a portion in which a corresponding element exists if the range contains no corresponding element between model A and model B. Then, conversion is applied to the extended range for generating a difference. For models A and B having a tree-structure, for example, the difference generation area is extended from an element for which no corresponding element is detected toward the root of the tree.

A second approach to apply this method to conversion in which the number of elements of model B that correspond to elements of model A increases or decreases is to reference conversion rules to determine a difference generation range.

An example will be considered in which a change is made to the child attribute of node s2 of model A in the decrease type conversion shown in FIG. 10A. There is no element in the target model that corresponds to node s2 itself. However, the subtrees under node s1 can be included in a difference generation range according to the first approach. According to the second approach, node d1 can be determined as a node to which model generation and difference generation are applied, by following the rule that the child attribute of node s2 can be converted into the child attribute of node d1.

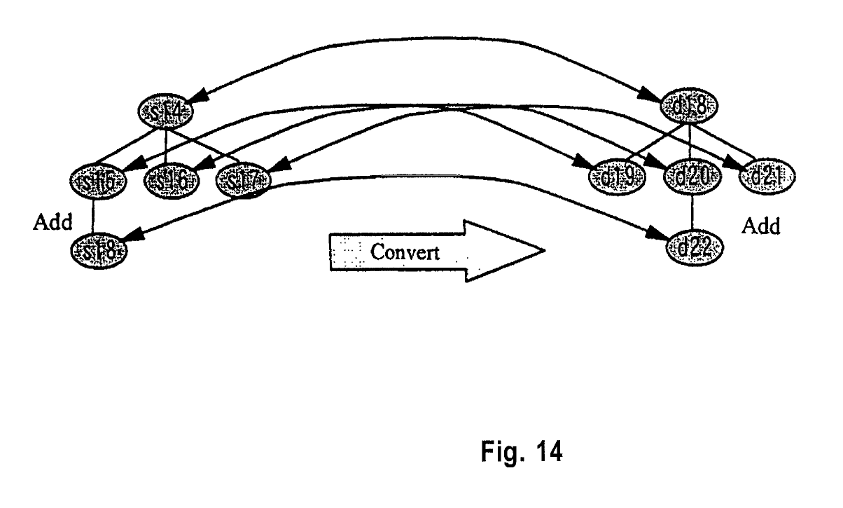

FIG. 14 shows an example of model conversion that does not meet the above-described condition. That is, in this conversion, a change in model B cannot be predicted from a change made to model A.

Referring to FIG. 14, first, node s14 of model A is converted into node 18 of model B. Then, the descendants of node s14 in model A are associated with the descendants of node d18 in model B. This allows then nodes s15, s16, and s17, which are the descendants of node s14, to be converted into nodes d19, d20, and d21 of model B, respectively.

Here, the descendant of node s15 in model A is associated with the descendant of node d20, rather than node d19, which is its corresponding element in model B. Thus, node s18, which is the descendant of node s15, is converted into node d22 of model B (the descendant of node d20). Because the conversion of this portion does not meet the above-described condition, a change portion of model B cannot be predicted from the change made to model A in model conversion as shown in FIG. 14.

Conversion rules for accomplishing the above-described conversion are shown below.

1.s14−>d18

2.s14.child (0)−>d18.child (0)

3.s14.child (1)−>d18.child (1)

4.s14.child (2)−>d18.child (2)

5.s15−>d19

6.s16−>d20

7.s17−>d21

8.s15.child (0)−>d20.child (0)

9.s18−>d22

Among the above-described conversion rules, the eighth rule in the conversion rules does not meet the above-described condition. Therefore, a change portion in model B cannot be predicted from the change in model A in the model conversion shown in FIG. 14.

However, if model conversion as shown in FIG. 14 is not encountered, a change portion in model B can be predicted from a change in model A. Therefore, operation costs required for the model conversion and extracting a difference between model Bs before and after the change can be significantly reduced by limiting a range to which this method is applied.

The reduction in the operation costs by this method will be concretely further considered below.

First, a case will be considered where the number of elements does not increase, for simplicity. In this case, the computational complexity of model conversion cost Vconv, and difference generation cost Vdiff, are O (1) because only one element is required to be converted and compared with its target element. Accordingly, only cost Vupdate required for event interpretation and re-rendering is O (n), which is not a constant. Thus, the operation cost can be significantly reduced compare with operation cost Vt0 defined in equation (2) in the method of re-creating view B in which updated model B is reflected.

In a case where the number of elements increases, a difference generation range should be extended as described above. The range is predetermined by conversion rules or the like. Therefore, computational complexity of model conversion cost Vconv, and difference generation cost Vdiff are O (1). Thus, the operation cost can be significantly reduced compared with operation cost Vt0 defined in equation 2.

A method will be described in which an event is generated for updating view B based on a change made to model A without extracting a difference between target model (model B) before and after the update.

The problem of how to cause an edit made in application A to be reflected in view B in model conversion for using view B in application B to display model A of application A can be reduced to the problem of what event should be generated for target view B.

In the first and second embodiments described above, an event is generated for updating model B in response to a change made to model A, extracting a difference between model Bs before and after the update, and identifying the change in model B based on the difference to update view B.

In a third embodiment, on the other hand, converting an event generated for updating view A in application A can also be converted into an event for directly updating view B in application B.

Like the first embodiment, the third embodiment is implemented by a computer system as shown in FIG. 1.

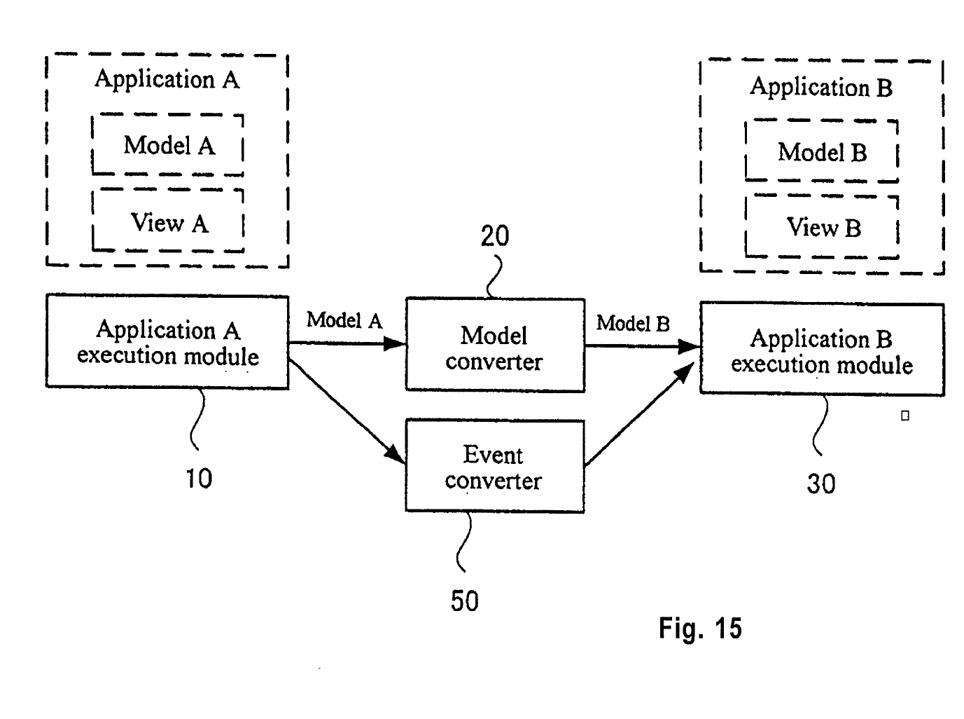

FIG. 15 shows functional blocks for editing an application according to the third embodiment.

Referring to FIG. 15, provided in the third embodiment are an application A execution module 10 for executing application A, a model converter 20 for converting model A in Application A into model B in application B, an event converter 50 for converting an event updating view A in application A into an event updating view B in application B, and an application B execution module 30 for executing application B.

Among these components, the application A execution module 10, model converter 20, and application B execution module 30 are the same as those shown in FIG. 2 and are therefore labeled with the same reference number and the description of which will be omitted. The relationship between application A and application B is the same as that described with respect to FIG. 3 in the first embodiment.

The event converter 50 shown in FIG. 15 is a virtual software block in the CPU 101 controlled by a computer program loaded into the main memory 103 shown in FIG. 1.

When model A is updated in application A, an event generated for updating view A in response to the update is input into the event converter 50 in the configuration in FIG. 15. Then, based on this source event and a conversion rule used by the model converter 20 to convert model A into model B, an event is generated for updating view B in application B with the change made to model A.

Because the event for updating view B is generated by the event converter 50 in the third embodiment, the application B execution module 30 can update view B simply based on that event. Accordingly, the difference extractor 31 and event generator 32 shown in FIG. 2 are not required.

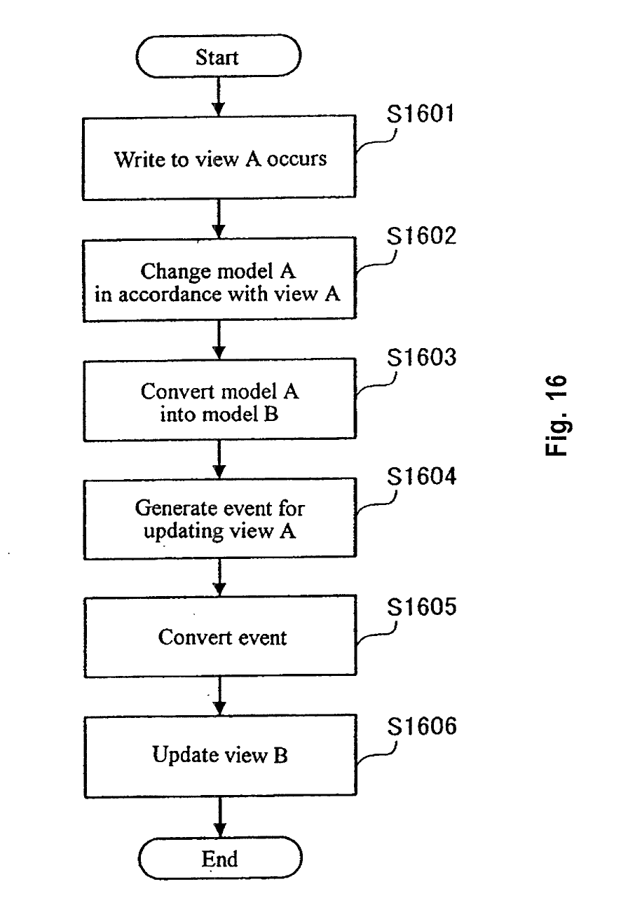

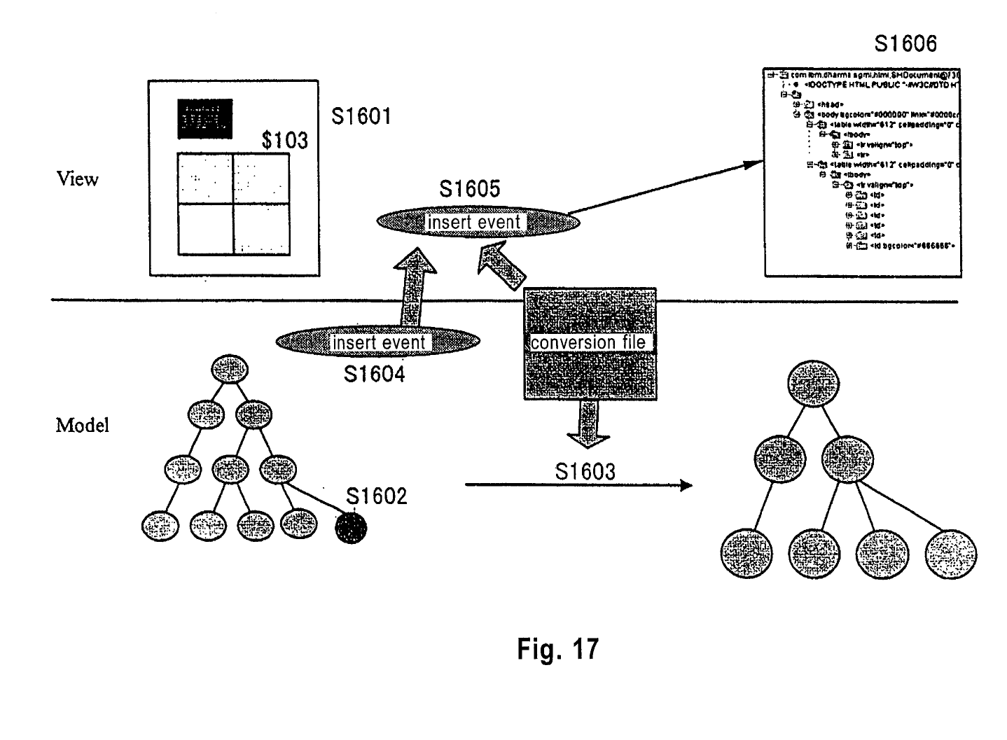

FIG. 16 shows a flowchart of a process for updating a model and view performed by the application A execution module 10, model converter 20, event converter 50, and application B execution module 30 described above. FIG. 17 shows how the update process is applied to the model-view pair shown in FIG. 3. Reference numbers in FIG. 17 correspond to steps in FIG. 17.

As shown in FIG. 16, when a write to source view A occurs (step 1601), the application A execution module 10 makes a change to model A according to changed view A (step 1602). This update of model A is reported from the application A execution module 10 to the model converter 20.

The model converter 20 receive the report from the application A execution module 10, generates model B in which the change in model A is reflected, and provides it to the application B execution module 30 (step 1603).

An event for updating view A with the change in model A is generated by the application A execution module 10 (step 1604). Then, the event converter 50 uses the event generated by the application A execution module 10 and model conversion to generate an event for reflecting the change in the model B on the view B and provides it to the application B execution module 30 (step 1605). This event updates view B with the change made to model A in the application B execution module 30 (step 1606).

If models A and B have a tree structure, typical conversion rules used are a conversion in which nodes are in one-to-one correspondence (normal conversion), a node deletion, a node insertion, and a change (replacement) of an attribute assigned to a node. Any complicated changes can be represented by combinations of these rules (other, special conversions are those in which the number of nodes (elements) increases or decreases as described with respect to the second embodiment and shown in FIG. 10).

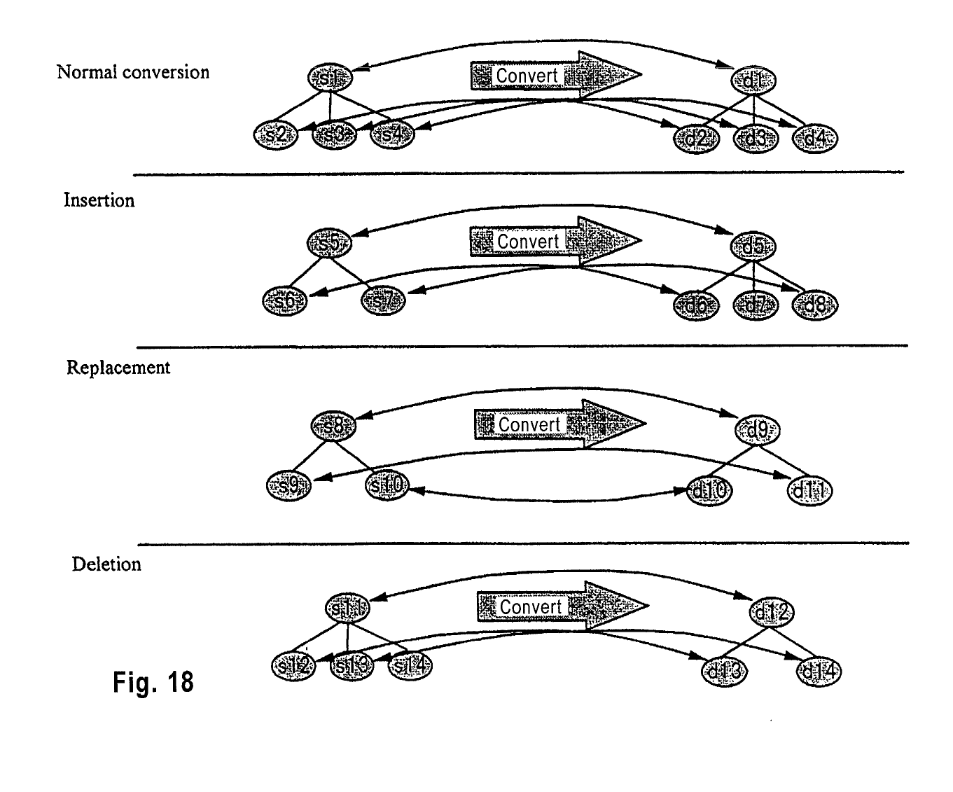

FIG. 18 shows these conversion rules. What event is generated for model B based on conversion rules applied to relevant elements of model A will be described below with respect to the three conversion rules in which tree structures are changed, that is, a node deletion, a node insertion, and a change of attribute assigned to nodes.

Let a relevant element of source model A (hereinafter called source element) be “d”, mapping for obtaining a corresponding element in model B (hereinafter called target element) be “map”, and a target element obtained from element “d”be “map (d)”. It is assumed that source and target elements have attributes, “parent”, array-type “children”, or “index”, which indicates that the element is the nth child of the parent. Let an event that occurs in model A (hereinafter refer to source event) be “se”. Let an event that occurs in model B (hereinafter called target event) be “de”. Each event has four attributes, “target”indicating a node to be changed, “element”indicating an element to be inserted or deleted, “index”indicating an inserted or deleted portion, and “type (REMOVE, INSERT, or CHANGED)”indicating the type of the event.

Under these conditions, the event converter 50 uses mapping “map”from source event se to determine the attribute of target event de as follows.

de.type=f (se.type, se.target, se.element), where f is a function for obtaining the type of a change in the target element from the type of a change in the source element d, the change object, and the element to be inserted/deleted.

de.target=map (se.target). If the value is null, the target event de is discarded (the event is not generated).

de.element=map (se.element).

de.index=map (se.element).index.

An example will be described below in which this embodiment is applied to a specific application.

### FIRST EXAMPLE

In this example, as an application an HTML editor developed by mapping an HTML DOM to a text component supplied with Java® 2 Platform, Standard Edition provided by Sun Microsystems in U.S.A. is used.

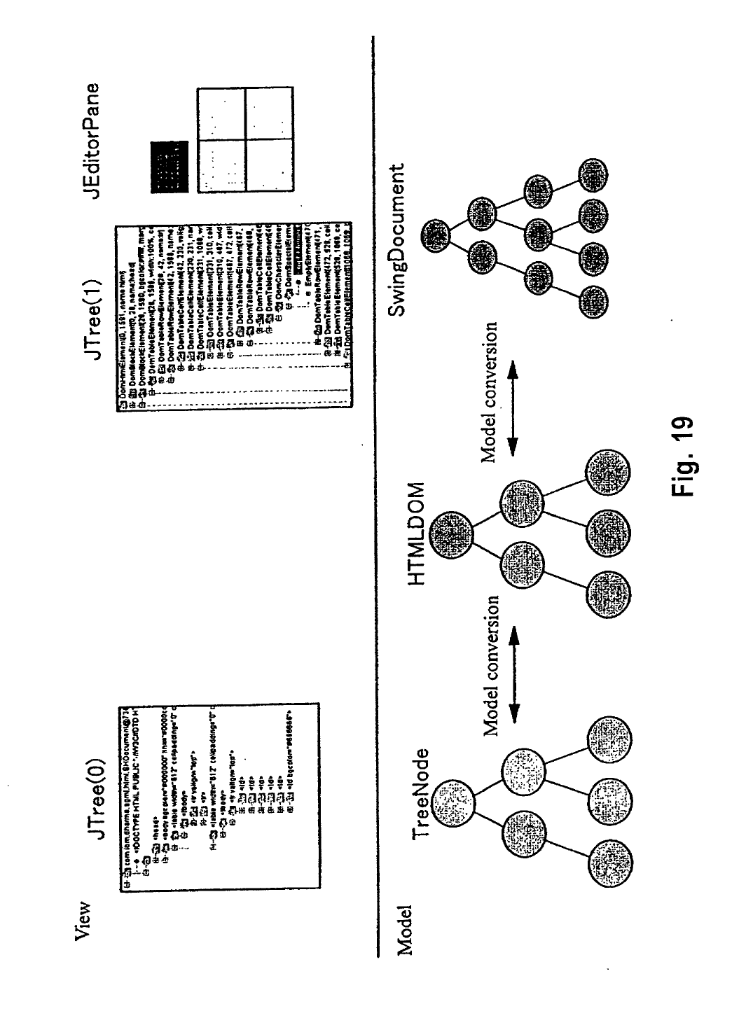

FIG. 19 shows the internal structure of the HTML editor.

In FIG. 19, model HTMLDOM has a tree structure having a DOM interface in HTML.

View Jtree (0) (tree presentation) is an instance of java® x.swing.Jtree. Model TreeNode is a model of view Jtree (0) and provides a java® x.swing.tree.TreeNode interface converted from DOM.

View JEditorPane (WYSIWYG view) is an instance of java® x.swing.JEditorPane. Model SwingDocument is a model of view JEditorPane and provides a java® x.swing.text.Document interface converted from DOM. The model SwingDocument also provides a TreeNode interface and accordingly has a view Jtree (1), which is a tree view.

Conversion between model HTMLDOM and model TreeNode is a simple one-to-one conversion. Therefore, view Jtree (0) is the same as the view of model HTMLDOM. Hence, in the following description, conversion from model HTMLDOM into model SwingDocument will be described. The model conversion according to the second embodiment will be used (that is, model conversion is performed for each corresponding element).

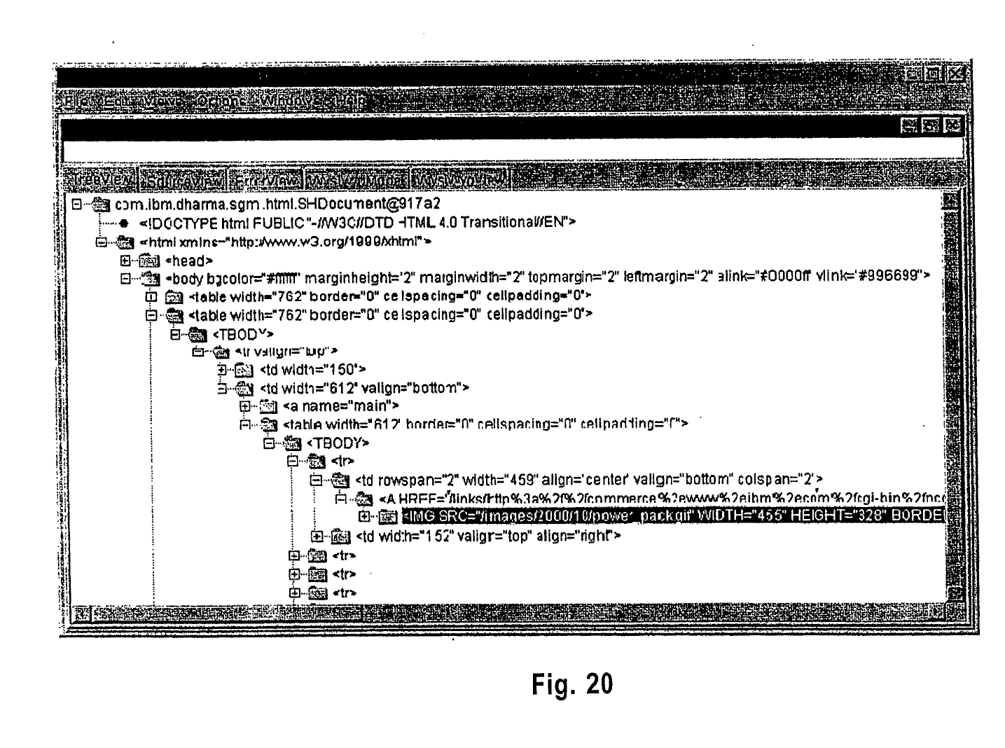

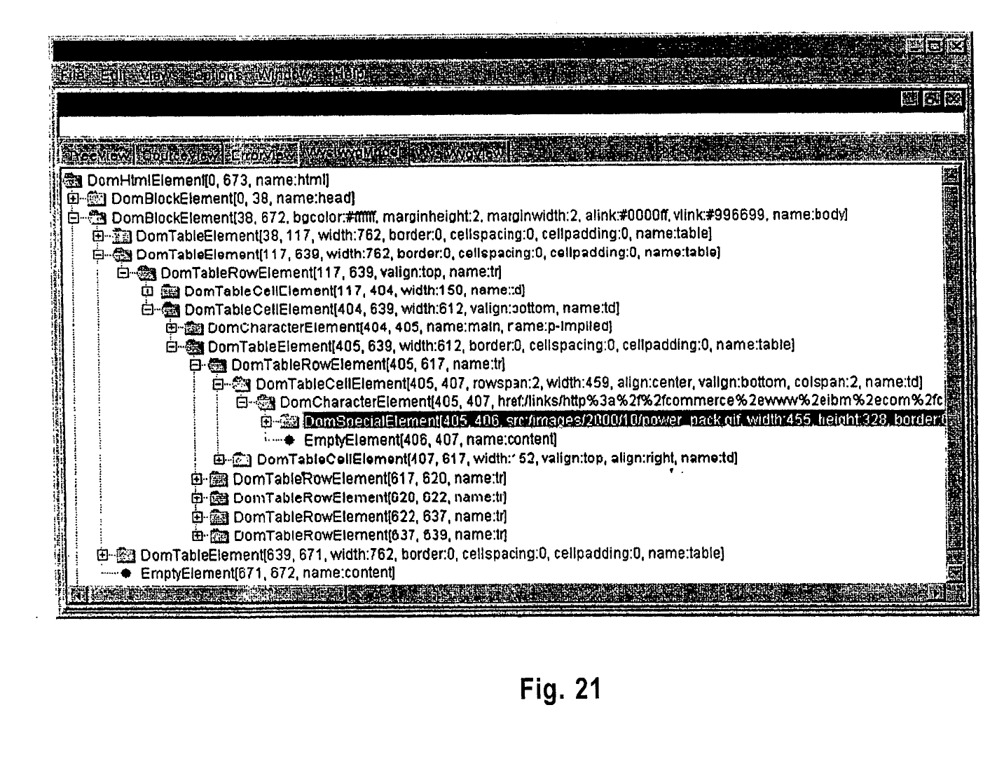

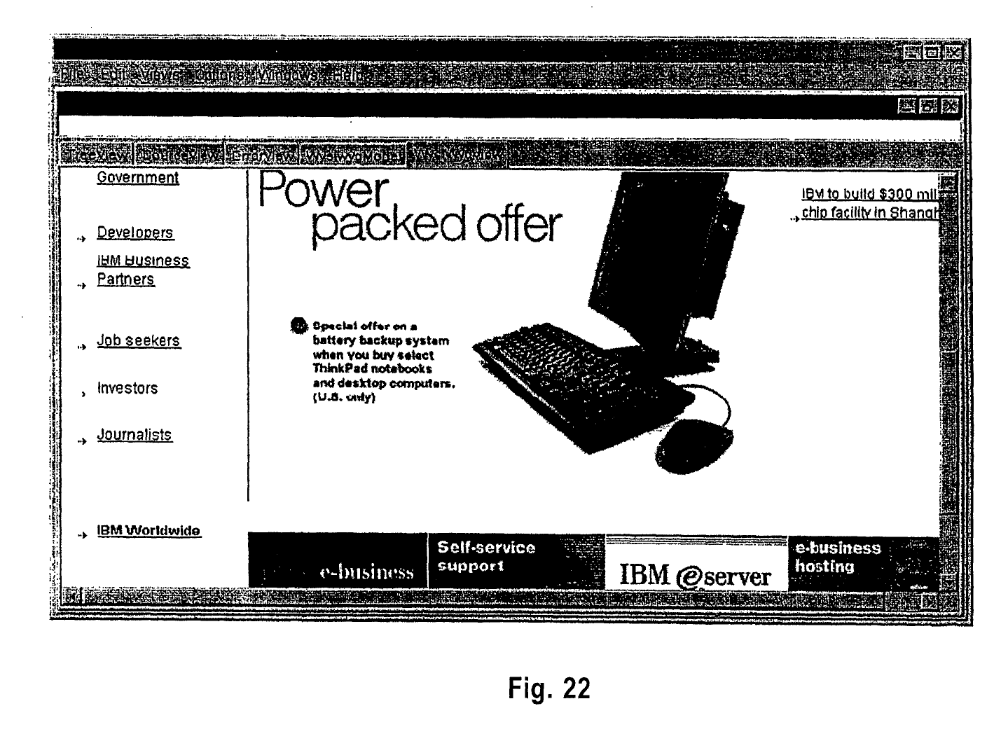

FIG. 20 shows a screen image displayed in view JTree (0) using a Web page ( ) of IBM Corporation as model HTMLDOM. FIG. 21 shows a screen image of this Web page displayed in view Jtree (1). FIG. 22 shows a screen image of the same Web page displayed in view JEditorPane.

It is assumed here that an operation is performed for deleting a DOM node (IMG0) representing image data including title “Power packed offer displayed in the portion adjacent to the center in FIG. 22”.

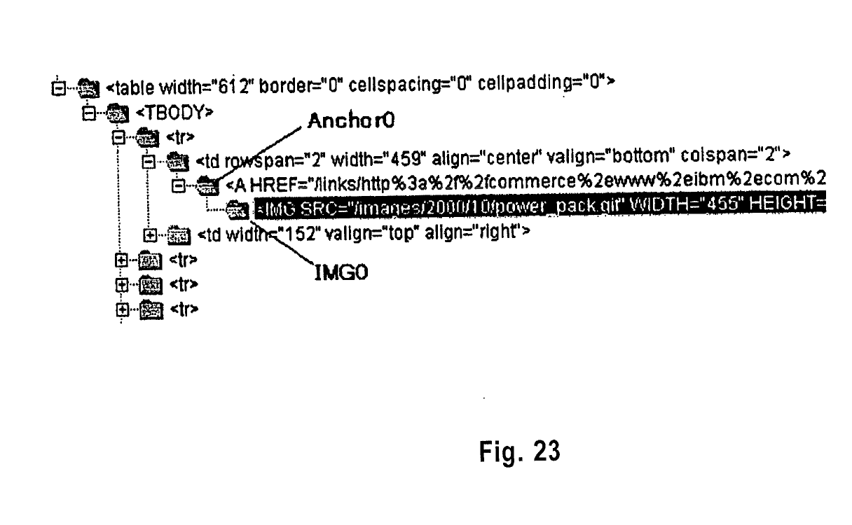

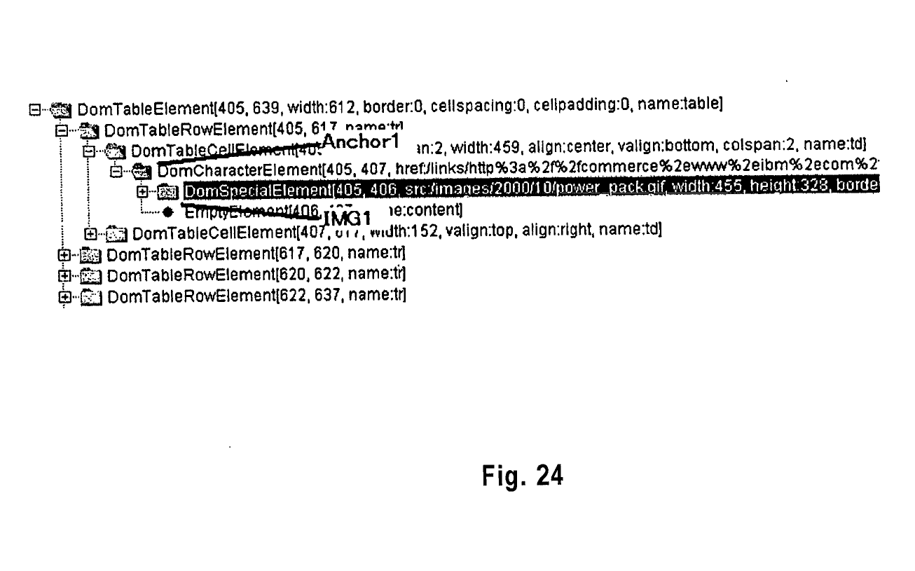

FIG. 23 shows a portion including this node (IMG0) in model HTMLDOM before the node (IMG0) is deleted. FIG. 24 shows a portion including a corresponding node (IMG1) in model SwingDocument converted from model HTMLDOM. The image of model HTMLDOM in FIG. 23 is represented by using view JTree (0), which provides a tree view.

Similarly, the image of SwingDocument in FIG. 24 is represented by using view JTree (0), which also provides a tree view.

In FIG. 23, the parent node of node (IMG0) is node (Anchor0). In FIG. 24, the parent node of node (IMG1) is node (Anchor1).

The conversion rules for converting model HTMLDOM into model SwingDocument are shown below.

1.TABLE→DomTableElement

2.TABLE.child (0)→Null

3.TBODY→Null

4.TBODY.child (0)→DomTableElement.child (0), TBODY.child (1)→DomTableElement.child (1), . . .

5.TR→DomTableRowElement

6.TD→DomTableCellElement

7.A→DomCharacterElement, DomCharacterElement.lastChild=EmptyElement (the left side term indicates the last child)

8.IMG→DomSpecialElement

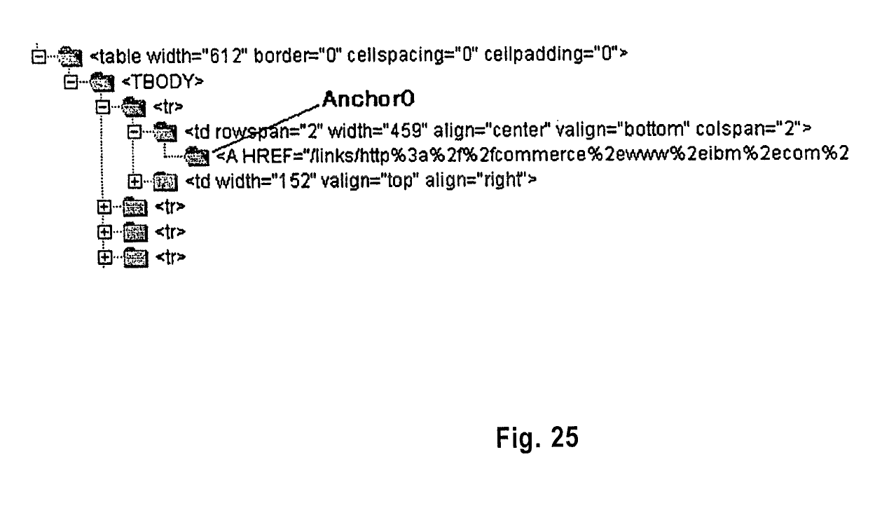

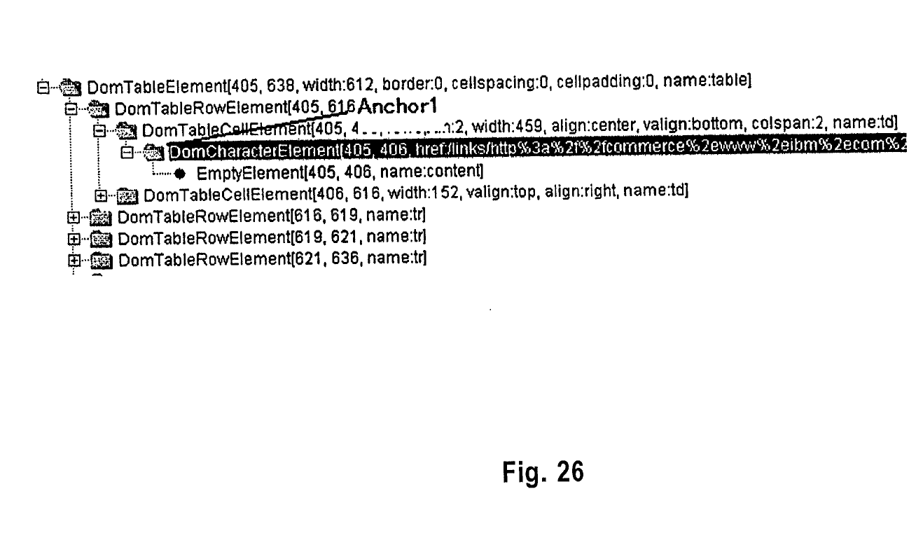

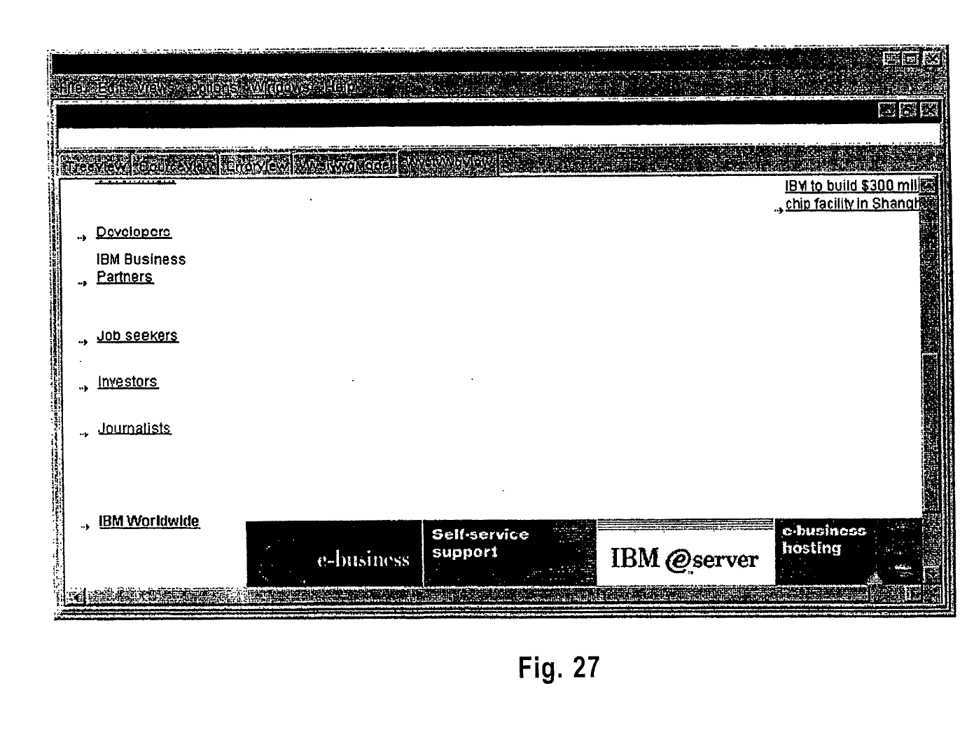

FIG. 25 shows the image in FIG. 23 from which node (IMG0) is deleted. FIG. 26 shows a portion including the corresponding node (Anchor1) in model SwingDocument converted from model HTMLDOM. FIG. 27 shows a screen image of model SwingDocument shown in FIG. 26 displayed in view JEditorPlane.

Referring to FIGS. 25 and 26, the deletion of node (IMG0) from model HTMLDOM results in the deletion of node (IMG1) from model SwitngDocument. Referring to FIG. 27, it shows that the image data corresponding to node (IMG1) is deleted from view JEditorPane.

In this example, the element of source element model (HTMLDOM) in which the change that cause node (IMG0) to be deleted occurs was node (Anchor0). Therefore, the model converter 40 uses the sub-converter 41 to convert the node (Anchor0) of model HTMLDOM into the node (Anchor1) of model SwingDocument.

Then, the difference extractor 31 of the application B execution module 30 compares node (Anchor1), which it has held before the conversion, with node (Anchor1) received from the model converter 40. This comparison shows that node (IMG1), which the first child of node (Anchor1), is deleted and this deletion is extracted as a difference.

Then, the event generator 32 of the application B execution module 30 generates an event for causing this difference to be reflected in view JEditorPane and provides it to view JEditorPane. This event is an instance providing a java® x.swing.event.DocumentEvent interface. The actual content of this event are as shown below.

DocumentEvent

Offset of the position at which the event occurs from the beginning of the document: 405

Length of the area subject to the event: 1

Type of the event: REMOVE

Element for which the event occurred: Anchor1

Child event held after the change: 0th child: EmptyElement (405, 406, name:content)

Child index subject to the event: 0

Child event removed: IMG0When view JEditorPane receives this event, the displayed contents is updated as shown in FIG. 27.

### SECOND EXAMPLE

In a second example, an XML editor having the function of previewing HTML converted by XSL is used. Model conversion according to the second embodiment is also used in this example.

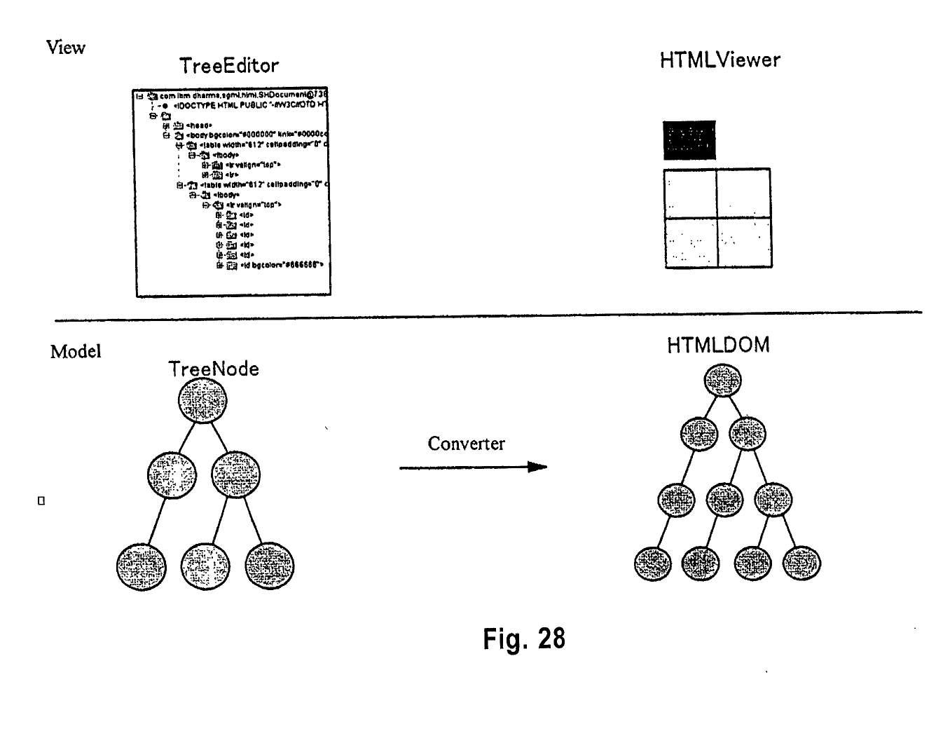

FIG. 28 shows an internal structure of the XML editor. In FIG. 28, a model-vie pair consisting of model TreeNode and view TreeEditor is a typical XML tree editor (for example Xeena from IBM). The tree editor model, TreeNode, is converted by the model converter 40, which is an XSLT processor, into an HTML DOM (model HTMLDOM). Model HTMLDOM is displayed in WYSIWIG format in view “HTML Viewer”. View HTML Viewer may be a typical Web browser.

If a change is made to model TreeNode by the tree editor, the changed position is reported to the XSLT processor and a corresponding position in model HTMLDOM is changed through conversion by the XSLT processor.

Then the application B execution module 30 calculates a difference between model HTMLDOMs before and after the change. The difference is used as a parameter to generate an event for updating view HTML Viewer and the event is provided to view HTML Viewer. The view HTML Viewer is updated with the change reflected in model TreeNode based on the event received.

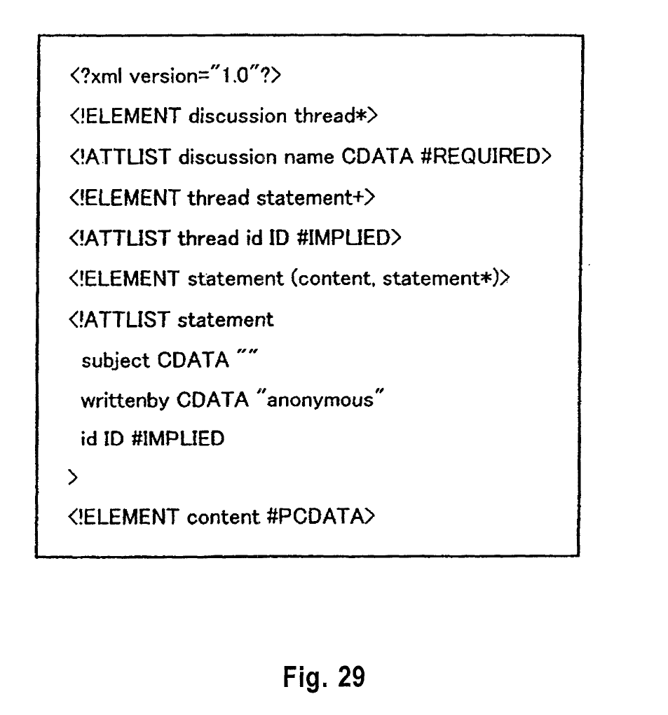

An example will be considered below in which the above-mentioned XML editor is used and document-type XML data shown in FIG. 29 is converted into compact HTML used in a device such as a PDA to preview it.

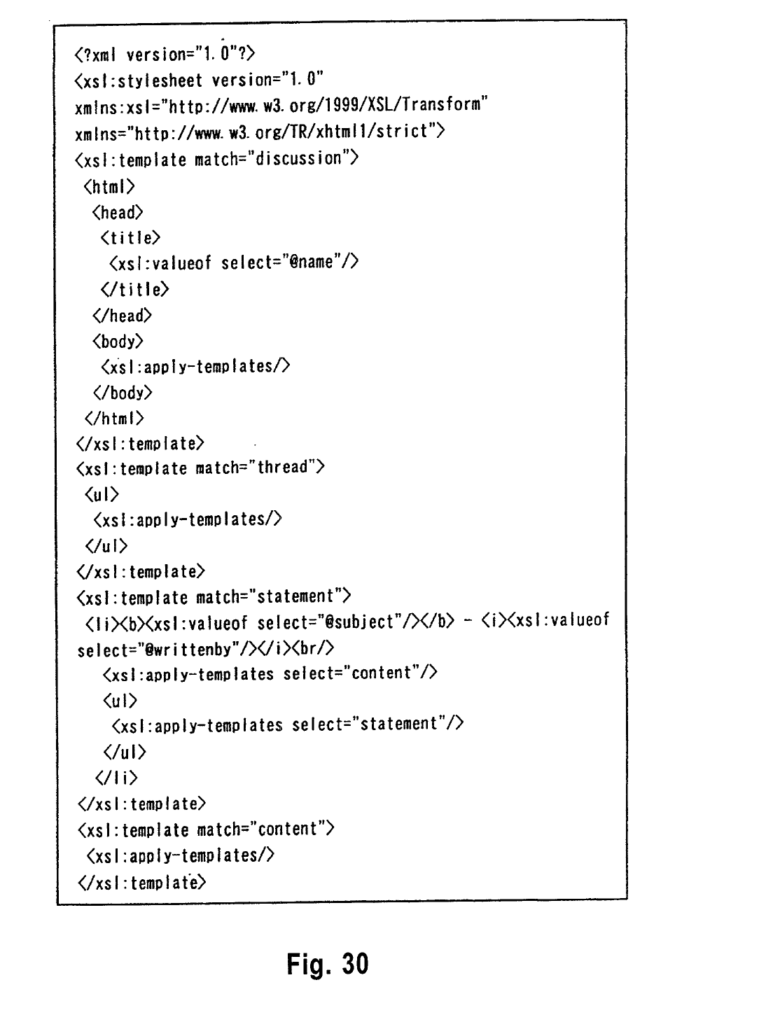

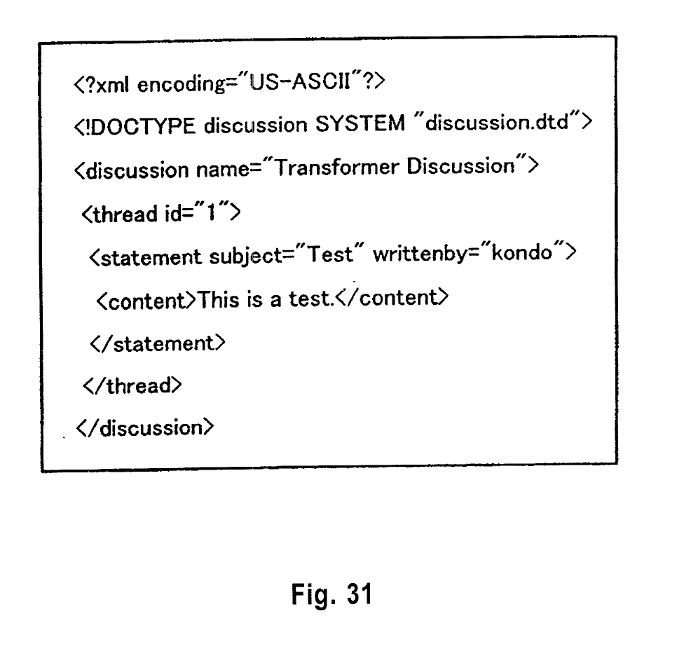

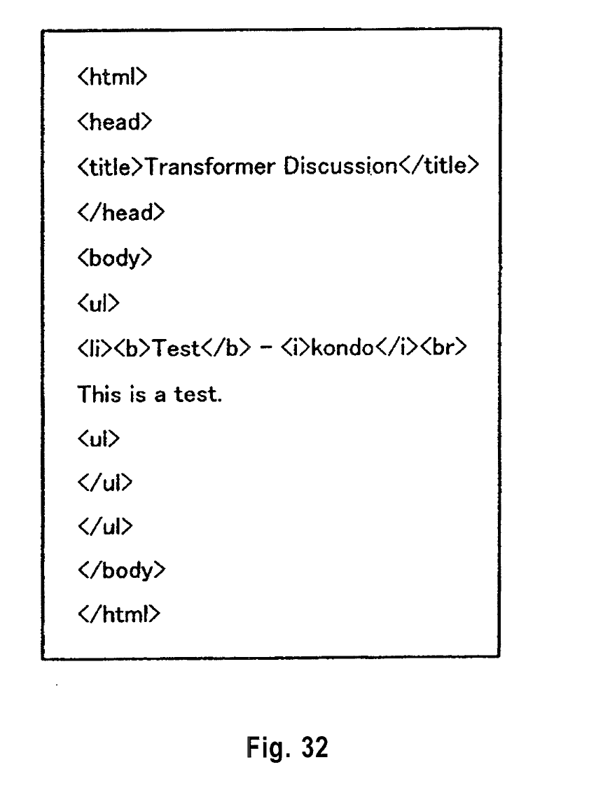

FIG. 30 shows an example of an XSL style sheet in which this conversion is implemented. FIG. 31 shows an example of XML data, which is a source model (model A). FIG. 32 shows compact HTML data, which is the target model (model B) obtained by converting the model shown in FIG. 31. Data in shown in FIGS. 31 and 32 is displayed in views A and B, respectively, which are source views.

A subtree represented by a document fragment as provided below is inserted after a “content” element as a change to the XML data (FIG. 31), which is the source model.

<statement subject=“OK”>

<content>OK</content>

</statement>

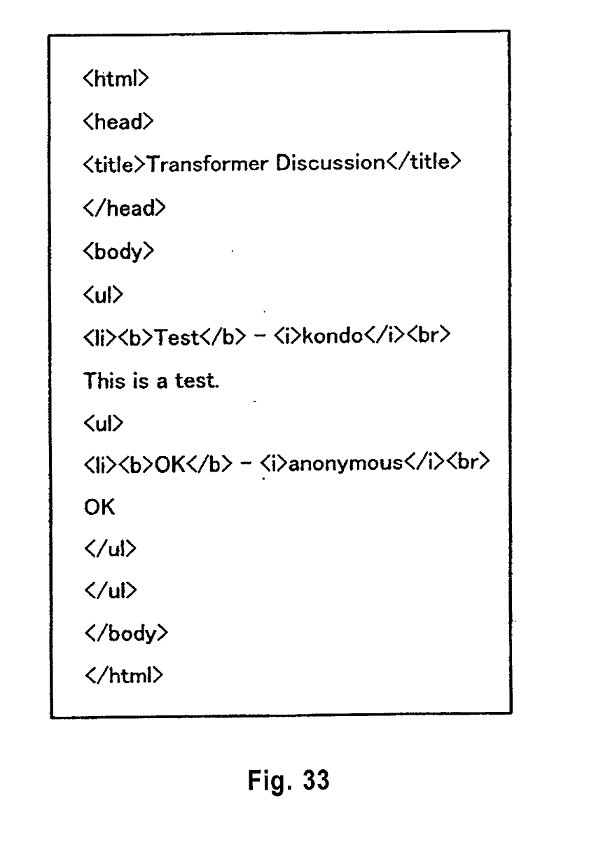

In response to this change, the XML processor, which is the model converter 40, converts the “statement” element in the XML data (FIG. 31) to generate compact HTML data in which this change is reflected. FIG. 33 shows the generated compact HTML data.

It can be seen that a difference calculation is performed for the portion below the first ul element and li element is added to the second ul element during this conversion. Thus, the application B execution module 30 generates a DOM updating event as shown below to update view HTML Viewer.

MutationEvent

Type of event: INSERT

Element for which the event occurs: Second ul element

Index of chilled which is the target of the event: 0

Added child element: Second li element

### THIRD EXAMPLE

The examples in which models having a tree structure have been described above. A third example can be applied to conversion of models having other structures than a tree structure. In this example a source model (model A) having a two-dimensional array structure is converted into an HTML table.

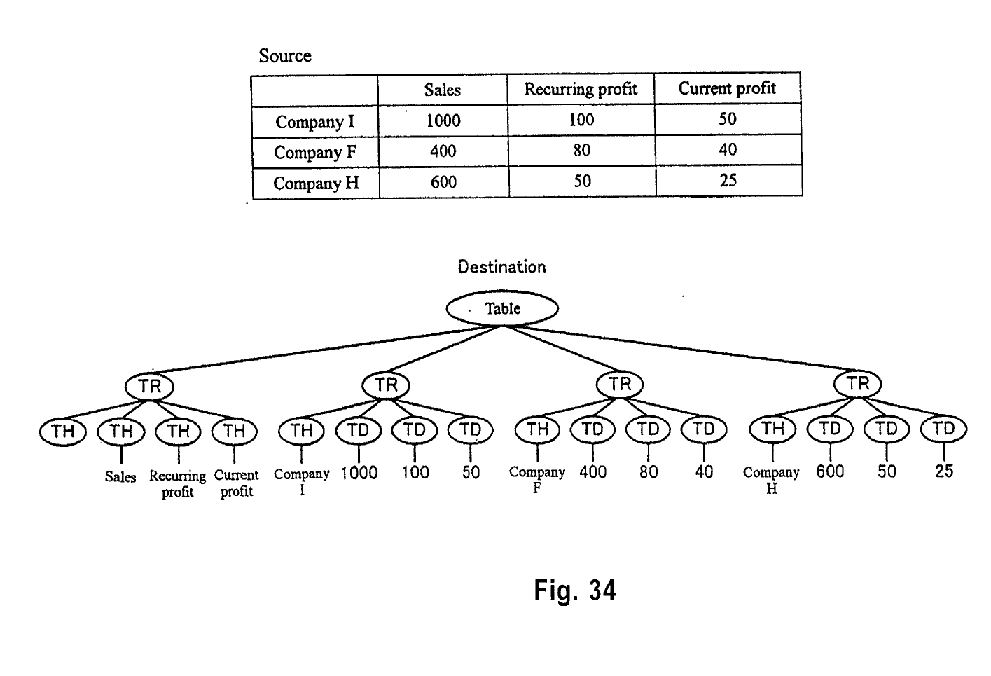

FIG. 34 shows models A and B before model A is converted.

In FIG. 34, model A is presented in a table view and model B is presented in a tree view of an HTML table.

A case will be considered where the current income column is deleted from model A in FIG. 34.

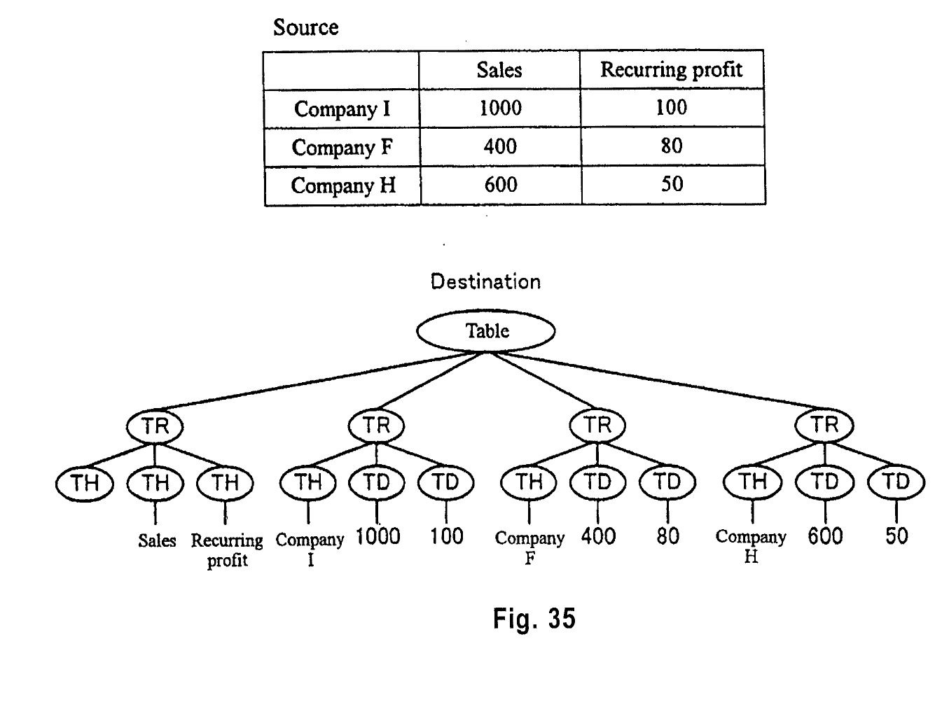

FIG. 35 shows models A and B after this change is made.

As shown in model A in FIG. 35, the current income column is deleted. When this change is made to model A, it is reflected in model B through model conversion. When a difference between elements before and after conversion under the TABLE element of model B is generated, it can be found that the right most element (element TH or TD) is deleted from each of elements TR. As a result, an event shown below occurs for elements TR.

MutationEvent

The type of event: REMOVE

Element for which the event occurs: TR element

Index of child which is the target of the event: 3

Deleted child element: element TD (TH for the first TR)

Although four events as described above occur at the same time, they are serialized and reported sequentially to the view because events cannot be reported in parallel from the model to the view.

As described above, in a case where a view of a different application is used from a given model through model conversion, a change made to the source model can be immediately reflected in its target model and view to update the view, according to the present invention.

In addition, in a case where a view of a different application is used from a given model through model conversion, a partial change corresponding to a change made to the source model can be made to its target view to update the view according to the present invention.

It is to be understood that the provided illustrative examples are by no means exhaustive of the many possible uses for my invention.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

1. An application editing apparatus for using a computer to edit an application having a model and a view separated from each other, comprising:
an editing module for editing a first model in said application;
a model converter for converting the first model edited by said editing module into a second model; and
a view display module for using a view of said second model to display said second model on a display device;
wherein said view display module comprises an event generator for generating an event based on an update in said second model if said second model is updated based on an edit of said first model made by said editing module and changes the view displayed on said display device based on the event generated by said event generator.

2. The application editing apparatus according to claim 1, wherein said view display module further comprises a difference extractor for extracting a difference between said second models before and after an update if said second model is updated based on an edit of said first model made by said editing module; and
said event generator generates said event by using information about said difference extracted by said difference extractor as a parameter.

3. The application editing apparatus according to claim 1, wherein said model converter converts an individual element of said first model into a corresponding element of said second model.

4. The application editing apparatus according to claim 1, wherein, if said second model contains no element corresponding to a converted element of said first model, said model converter adds an element corresponding to said converted element to said second model.

5. The application editing apparatus according to claim 1, wherein said model converter converts an element edited by said editing module in said first model into a corresponding element in second model and updates said second model with said converted element.

6. An application editing apparatus for using a computer to edit an application having a model and a view separated from each other, comprising:
an editing module for editing a first model in said application;
a model converter for converting the first model edited by said editing module into a second model;
a view display module for using a view of said second model to display said second model on a display device; and
an event converter for converting an event causing an update made to said first model to be reflected in a view of said first model into an event changing the view of said second model by using a conversion rule for converting said first model into said second model,
wherein said view display module changes the view displayed on said display device based on the event generated by said event converter.

7. A data processing method of using a computer to display a model in a given application in a view in another application, comprising the steps of:
reading a second model in said another application from a data storage storing said given application and updating said second model so that the update is reflected in said second model if a first model in said given application is updated; and
generating an event based on the update made to said second model and, based on said event, changing the view displayed on a display device in said another application.

8. The data processing method according to claim 7, wherein said step of changing the view in said another application comprises the steps of:
extracting a difference between said second models before and after the update;
making a change corresponding to said difference to said second model before update to generate said event; and
changing said view based on said event.

9. The data processing method according to claim 8, wherein said step of updating said second model comprises the step of converting an individual element of said first model into a corresponding element of said second model, and
said step of changing the view in said another application comprises the step of extracting a difference in the individual converted element of said second models before and after the update.

10. The data processing method according to claim 7, wherein said step of changing the view in said another application comprises the step of converting an event causing the update made to said first model to be reflected in a view in said given application into an event changing the view in said another application by using a conversion rule for converting said first model into said second model.

11. A program for controlling a computer to execute an application having a model and a view separated from each other, said program causing said computer to perform the process steps of:
reading a model in said application from a data storage storing said application and displaying a view of said model on a display device;
extracting an difference between said models before and after an update if said model is updated;
generating an event for changing said view based on said extracted difference; and
changing said view displayed on said display device based on said generated event.

12. A program for controlling a computer to edit an application having a model and view separated from each other, said program causing said computer to operate as:
an editing module for editing a first model in said application;
a model converter for converting the first model edited by said editing module into a second model;
a difference extractor for extracting a difference between said second model and said second model previously converted if said first model is converted by said model converter into said second model;
an event generator for generating an event based on the difference extracted by said difference extractor; and
a view display module for displaying said second model in a view of said second model and, based on the event generated by said event generator, changing the view displayed on said display device.

13. The program according to claim 12, wherein said model converter converts an individual element of said first model into a corresponding element of said second model.

14. The program according to claim 12, wherein said difference extractor extracts a difference between the converted elements before and after the update of said second model.
